(19) United States
(12) Patent Application Publication
(10) Pub. No.: US 2002/0143666 A1
(43) Pub. Date: Oct. 3, 2002

(54) Package data tracking system and method utilizing impulse radio communications

(75) Inventor: James S. Finn, Huntsville, AL (US)

Correspondence Address: WILLIAM J. TUCKER, 8650 SOUTHWESTERN BLVD. #2825, DALLAS, TX, 75206, US

(73) Assignee: Time Domain Corporation

(21) Appl. No.: 09/789,671

(22) Filed: Feb. 21, 2001

(51) Int. Cl. G06F 17/60

(52) U.S. Cl. 705/28

(57) ABSTRACT

An integrated data collection and transmission system and method for collecting and transmitting data related to package delivery. The system and method utilize various components that are commonly connected via impulse radios.

### BACKGROUND OF THE INVENTION

1. Field of the Invention

The invention relates generally to an integrates data collection and transmission system and method for collecting and transmitting data related to package delivery and more specifically wherein the system and method utilize various components that are commonly connected via impulse radios.

2. Description of Related Art

In today's mobile society the attempt to make traditional technologies mobile is pervasive. Whereas in the past people were satisfied in using their computer connected to a modem wired to a wall, or their telephones connected to a wired infrastructure or even plugging in a RS-232 cable for information download from a hand-held device to a computer, today people want to accomplish the same transfer of information wirelessly. Indeed, moving information from point A to point B wirelessly has vast advantages and thus technologies have been developed to accomplish this.

Infra red has been developed to accomplish this information transfer wirelessly; however, it has numerous drawbacks. First, since it is an optical solution it is inherently line of sight and useful only for short ranges. Second, anything placed between the transmitter and receiver will block the transmission. Third, infra red has limited data rates and lack of ability for high bandwidth.

Another wireless methodology of transferring information in a wireless fashion that has been developed is called Bluetooth. It is the joint effort of 3Com, Ericsson, Intel, IBM, Lucent, Microsoft, Motorola, Nokia and Toshiba. Bluetooth operates in a band of radio frequencies just above 2,400 MHz (2.4 GHz), a band that is internationally allocated for unlicensed users of industrial, scientific and medical radio devices. Bluetooth uses one of the family of techniques called “spread spectrum,” in which multiple users share a single slice of the spectrum but use sophisticated information processing to identify their own signals while ignoring others. Specifically, Bluetooth uses a technique called frequency hopping, in which senders and receivers follow pre-planned sequences of moves between narrow channels within an agreed-upon range. This rapid movement (1,600 hops per second) is not a search for a clear channel but is rather a statistical exercise.

However, Bluetooth-enabled devices don't provide the level of security that most people need. Further, the range of 100 feet gets seriously compromised when walls go up between devices. Further, in terms of speed, Bluetooth's top speed is about 720 Kbps, which is far below expected needs. Lastly, interference and multipath problems can plague Bluetooth. A pending FCC ruling allowing HomeRF to operate at a faster speed could cause interference with Bluetooth devices; and if a number of Bluetooth devices are co-located they can interfere with each other and have limited channelization.

One of the technologies that dramatically needed an improved wireless information transfer, is the package delivery and tracking industry. In recent years, overnight and other forms of package delivery have become embedded within our business culture. Customers demand increasingly quick delivery times and expect to receive up-to-the-minute information about the status of packages they deliver and expect to receive. In order to meet these needs and expectations, it is necessary for providers of package delivery services to continually innovate their services to provide their customers with the most up-to-date information about their shipments as possible.

Computerized parcel shipping systems are known in the prior art. One such system is disclosed in U.S. Pat. No. 4,839,813 issued to Hills et al. In accordance with the system disclosed in Hills et al., a user can track and record transactions of various different carriers and can store a file of records relating to the transactions. However, Hills et al. does not disclose an integrated data collection and transmission system but merely provides for the user to maintain files relative to shipments made with different carriers. Hills et al. also does not disclose an integrated system in which various of the components exchange information via a common communications link.

U.S. Pat. No. 5,313,051 issued to Brigida et al. discloses a paperless parcel tracking system. The system disclosed in Brigida et al. includes a parcel tracking system that can include a bar code scanner and a touch panel display. The parcel tracking system also includes a host link to communicate with a host system. This communication can be accomplished via an infrared link, cellular or radio transmission, or conventional electrical contacts. Brigida et al. also shows that the parcel tracking system can be used with a docking station, which can function as a temporary host or function as an infrared I/O device attached to a host such as a personal computer. The parcel tracking system is often docked in the docking station to enable communications between the devices.

The system disclosed in Brigida et al. is, however, limited because it does not provide an integrated data collection and transmission system wherein a data collection device is capable of communicating with one or more peripheral devices and with one or more intermediate data storage devices. In addition, Brigida et al. shows that the parcel tracking system is docked within the docking station in order for a transfer of information to occur between the devices. This reduces the flexibility of the system because the parcel tracking system and the docking station must be physically connected for the transmission of data between the devices to occur.

U.S. Pat. No. 6,094,642 issued to Stephenson et al. discloses an integrated data collection and transmission system and method of tracking packages wherein various elements of the system are interconnected by a common communications link such that components of the system need not be physically connected to enable the transfer of data therebetween. However, the wireless communications link are a combination of infra red and micro radio links. Thus, the system disclosed in the '642 patent has inherent in its design all of the limitations and drawbacks of infra red technologies.

Hence, there is a need in the art to provide a system with integrated data collection and wireless transmission system and method of tracking packages wherein various elements of the system are interconnected by an improved wireless common communications link that does not have the drawbacks associated with infra red or Bluetooth technologies.

### BRIEF DESCRIPTION OF THE INVENTION

The present invention includes an integrated data collection and transmission system for package tracking comprising a data collection terminal capable of collecting and storing package tracking data, the data collection terminal including an impulse radio communications port, at least one peripheral device, associated with the data collection terminal, the peripheral device including an impulse radio communications port for receiving at least one communication from the data collection terminal and for performing a preselected operation related to package tracking based on the at least one received communication, an intermediate data storage device, associated with the data collection terminal, the intermediate data storage device including an impulse radio communications port for receiving the collected and stored package tracking data from the data collection terminal and a central data collection facility, capable of communicating with the intermediate data storage device, for receiving the collected and stored package tracking data from the intermediate data storage device and for maintaining an accessible package tracking database based on the collected and stored package tracking data.

The present invention also includes an integrated data collection and transmission system having a common impulse radio communications link between selected ones of its components comprising one or more bar code scanning devices, each having a memory, an informational display, a CPU, a keyboard for inputting information to the device, a power supply, and an impulse radio communications port for communicating with selected other components of the system including other of the bar code scanners, one or more intermediate data storage and processing devices provided with an impulse radio communications port for receiving information from one of the one or more bar code scanning devices and for communicating with the selected other components of the system, a printer with an impulse radio communications port capable of receiving a print command from one of the one or more bar code scanning devices, and a central computer with means for accepting, storing and transmitting data to and between the one or more intermediate data storage and processing devices.

In accordance with the purposes of the invention, as embodied and broadly described, the invention also includes a method of tracking package data using an integrated data collection and transmission system, the method comprising the steps of using a bar code scanner to collect and store package tracking data, transmitting a communication to a peripheral device via an impulse radio communications link, the peripheral device performing a preselected operation related to package tracking based on the command, transmitting the collected and stored package tracking data to an intermediate data storage device via an impulse radio communications link, transmitting the collected and stored package tracking data to a central data facility, and maintaining an accessible package tracking database based on the collected and stored package tracking data.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of the Gaussian Monocycle of FIG. 1A;

FIG. 1D represents the third derivative of the Gaussian Monocycle of FIG. 1A;

FIG. 1E represents the Correlator Output vs. the Relative Delay in a real data pulse;

FIG. 1F graphically depicts the frequency plot of the Gaussian family of the Gaussian Pulse and the first, second, and third derivative.

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy Plot and points out the coded signal energy spikes;

FIG. 3 illustrates the cross-correlation of two codes graphically as Coincidences vs. Time Offset;

FIGS. 4A-4E graphically illustrate five modulation techniques to include: Early-Late Modulation; One of Many Modulation; Flip Modulation; Quad Flip Modulation; and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS. 5D-5F illustrate a signal plot of various multipath environments.

FIG. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 is a block diagram of the integrated data collection and transmission system of the present invention.

FIG. 10 is a block diagram of an EST in accordance with the present invention.

FIG. 11 is a block diagram of a Power Pad in accordance with the present invention.

FIG. 12 is a schematic diagram of a printer in accordance with the present invention.

FIG. 13 is a schematic diagram of a data transfer device in accordance with the present invention.

FIG. 14 is a schematic diagram of a storage facility in accordance with the present invention.

FIG. 15 is a schematic diagram of an admonishment device in accordance with the present invention.

FIG. 16 is a schematic diagram of a docking station in accordance with the present invention.

FIG. 17 is a block diagram of a DADS terminal in accordance with the present invention.

FIG. 18 is a block diagram of a belt device in accordance with the present invention.

FIG. 19 is a block diagram of a conveyor device according to the present invention.

FIG. 20 is a block diagram of an STCID in accordance with the present invention.

### DETAILED DESCRIPTION OF THE EMBODIMENTS

Overview of the Invention

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

Impulse Radio Technology Overview

Recent advances in communications technology have enabled ultra wideband technology (UWB) or impulse radio communications systems “impulse radio”. Impulse radio has been described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued December 18, 1990) and U.S. Pat. No. 5,363,108 (issued November 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997), U.S. Pat. No. 5,764,696 (issued Jun. 9, 1998), and U.S. Pat. No. 5,832,035 (issued Nov. 3, 1998) to Fullerton et al.

Uses of impulse radio systems are described in U.S. patent application Ser. No. 09/332,502, titled, “System and Method for Intrusion Detection using a Time Domain Radar Array” and U.S. patent application Ser. No. 09/332,503, titled, “Wide Area Time Domain Radar Array” both filed on Jun. 14, 1999 both of which are assigned to the assignee of the present invention. The above patent documents are incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, low duty-cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation, time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

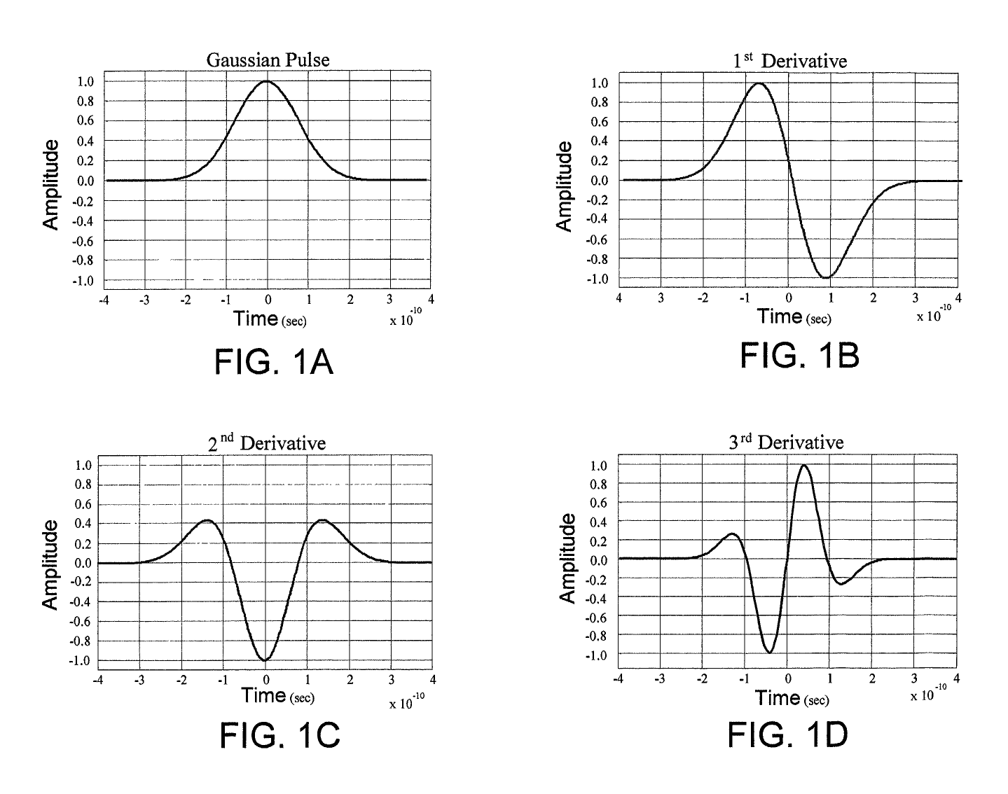

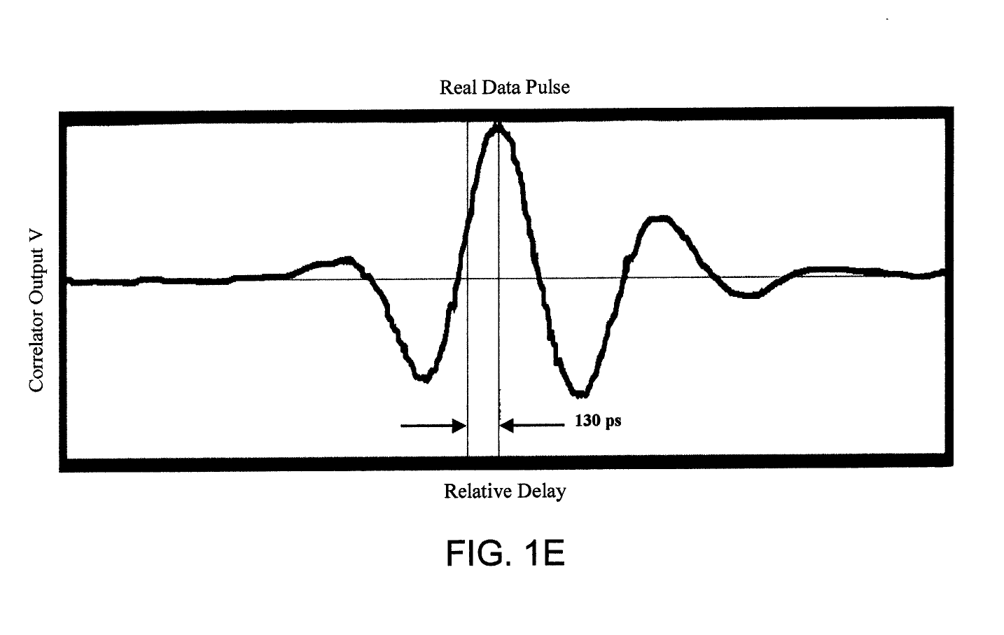

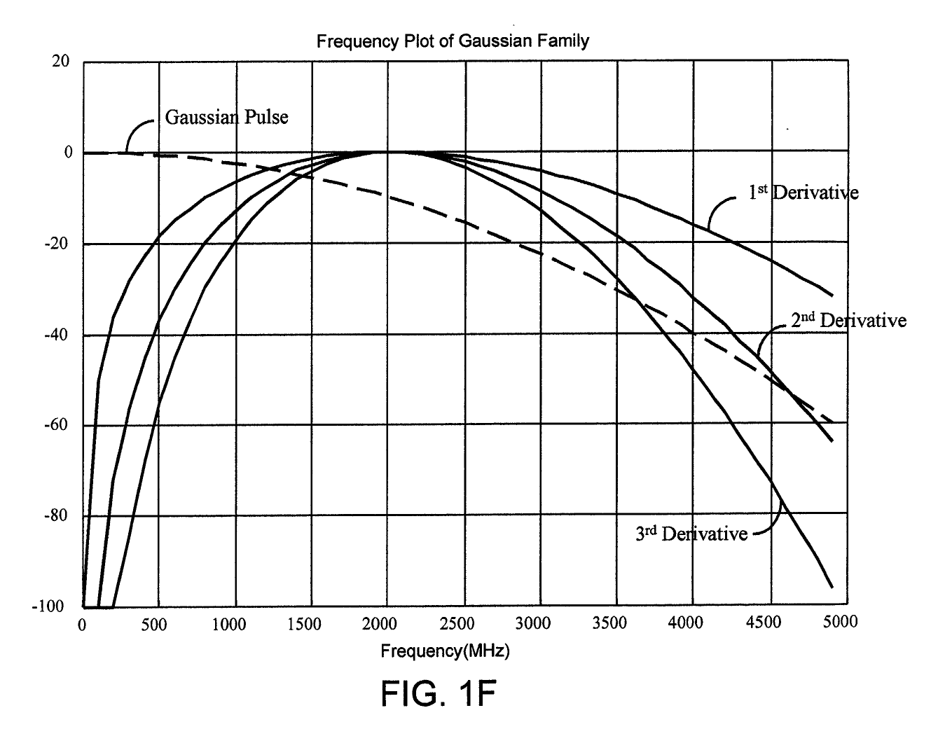

Impulse transmission systems are based on short, low duty-cycle pulses. Different pulse waveforms, or pulse types, may be employed to accommodate requirements of various applications. Typical pulse types include a Gaussian pulse, pulse doublet (also referred to as a Gaussian monocycle), pulse triplet, and pulse quadlet as depicted in FIGS. 1A through 1D, respectively. An actual received waveform that closely resembles the theoretical pulse quadlet is shown in FIG. 1E. A pulse type may also be a wavelet set produced by combining two or more pulse waveforms (e.g., a doublet/triplet wavelet set). These different pulse types may be produced by methods described in the patent documents referenced above or by other methods, as persons skilled in the art would understand.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{mono} ( t ) = \sqrt{e} ( \frac{t}{σ} ) {e}^{\frac{- {t}^{2}}{2 {σ}^{2}}}$$

where σ is a time scaling parameter, t is time, and e is the natural logarithm base.

The power special density of the Gaussian monocycle is shown in FIG. 1F, along with spectrums for the Gaussian pulse, triplet, and quadlet. The corresponding equation for the Gaussian monocycle is:

$${F}_{mono} ( f ) = {( 2 π )}^{\frac{3}{2}} σ f {e}^{- 2 {( πσ f )}^{2}}$$

The center frequency (f_{c}), or frequency of peak spectral density, of the Gaussian monocycle is:

$${f}_{c} = \frac{1}{2 πσ}$$

It should be noted that the output of an ultra-wideband antenna is essentially equal to the derivative of its input. Accordingly, since the pulse doublet, pulse triplet, and pulse quadlet are the first, second, and third derivatives of the Gaussian pulse, in an ideal model, an antenna receiving a Gaussian pulse will transmit a Gaussian monocycle and an antenna receiving a Gaussian monocycle will provide a pulse triplet.

Pulse Trains

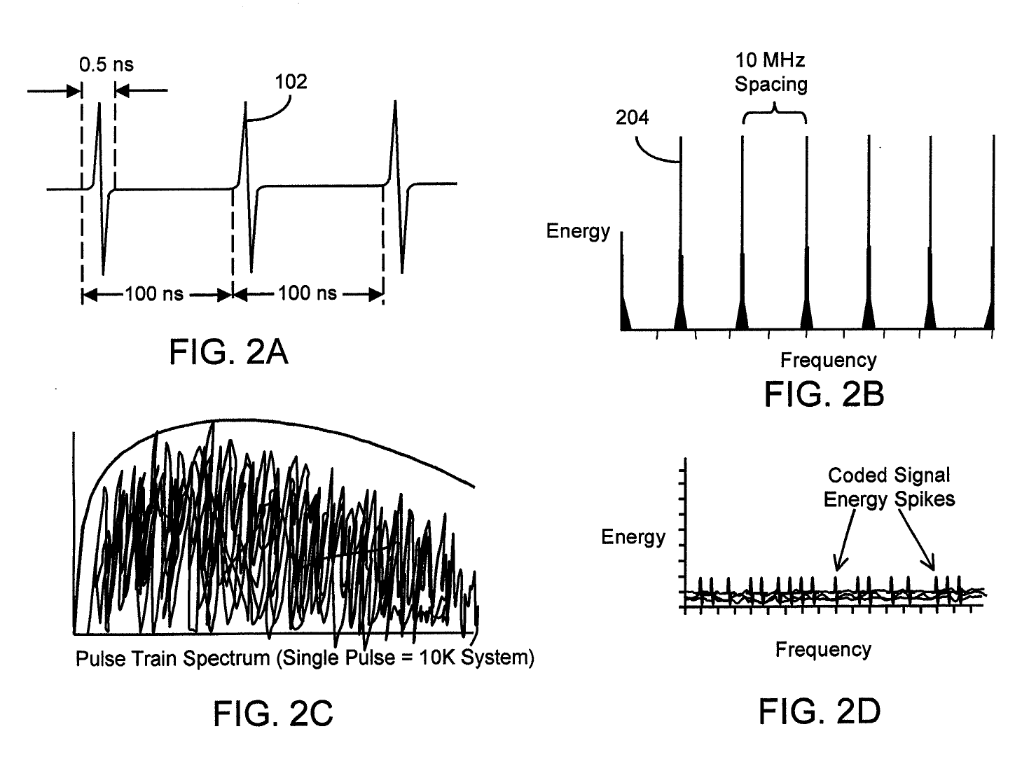

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems typically have very low average duty cycles, resulting in average power lower than peak power.

The duty cycle of the signal in FIG. 2A is 0.5%, based on a 0.5 ns pulse duration in a 100 ns interval.

The signal of an uncoded, unmodulated pulse train may be expressed:

$$s ( t ) = {( - 1 )}^{f} a {\sum }_{j} ω ( c t - j {T}_{f} , b )$$

where j is the index of a pulse within a pulse train, (−1)^{f} is polarity (+/−), a is pulse amplitude, b is pulse type, c is pulse width, ω(t,b) is the normalized pulse waveform, and T_{f} is pulse repetition time.

The energy spectrum of a pulse train signal over a frequency bandwidth of interest may be determined by summing the phasors of the pulses at each frequency, using the following equation:

$$A ( ω ) = \vert {\sum }_{i = 1}^{n} \frac{{ⅇ}^{jΔ t}}{n} \vert$$

where A(ω) is the amplitude of the spectral response at a given frequency . . . ω is the frequency being analyzed (2 πf), Δt is the relative time delay of each pulse from the start of time period, and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a PN code to vary inter-pulse spacing, the energy in the comb lines presented in FIG. 2B can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

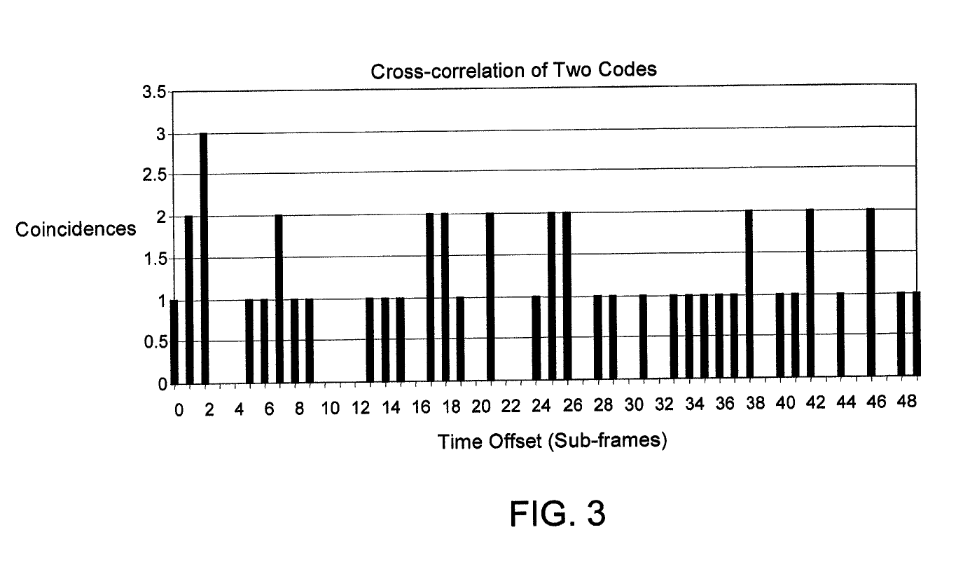

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,” Application No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned, co-pending application titled “A Method for Specifying Non-Allowable Pulse Characteristics,” application Ser. No. 09/592,289, filed Jun. 12, 2000, and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{t r}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, bⱼ^{(k)}, cⱼ^{(k)}, and ω(e,bⱼ^{(k)}) are the coded polarity, pulse amplitude, pulse type, pulse width, and normalized pulse waveform of the jth pulse of the kth transmitter, and Tⱼ^{(k)} is the coded time shift of the jth pulse of the kth transmitter. Note: When a given non-temporal characteristic does not vary (i.e., remains constant for all pulses), it becomes a constant in front of the summation sign.

Various numerical code generation methods can be employed to produce codes having certain correlation and spectral properties. Such codes typically fall into one of two categories: designed codes and pseudorandom codes. A designed code may be generated using a quadratic congruential, hyperbolic congruential, linear congruential, Costas array, or other such numerical code generation technique designed to generate codes having certain correlation properties. A pseudorandom code may be generated using a computer's random number generator, binary shift-register(s) mapped to binary words, a chaotic code generation scheme, or the like. Such ‘random-like’ codes are attractive for certain applications since they tend to spread spectral energy over multiple frequencies while having ‘good enough’ correlation properties, whereas designed codes may have superior correlation properties but possess less suitable spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned, co-pending application, titled “A Method and Apparatus for Specifying Pulse Characteristics using a Code that Satisfies Predefined Criteria,” application Ser. No. 09/592,288, filed Jun. 12, 2000, and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify-value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

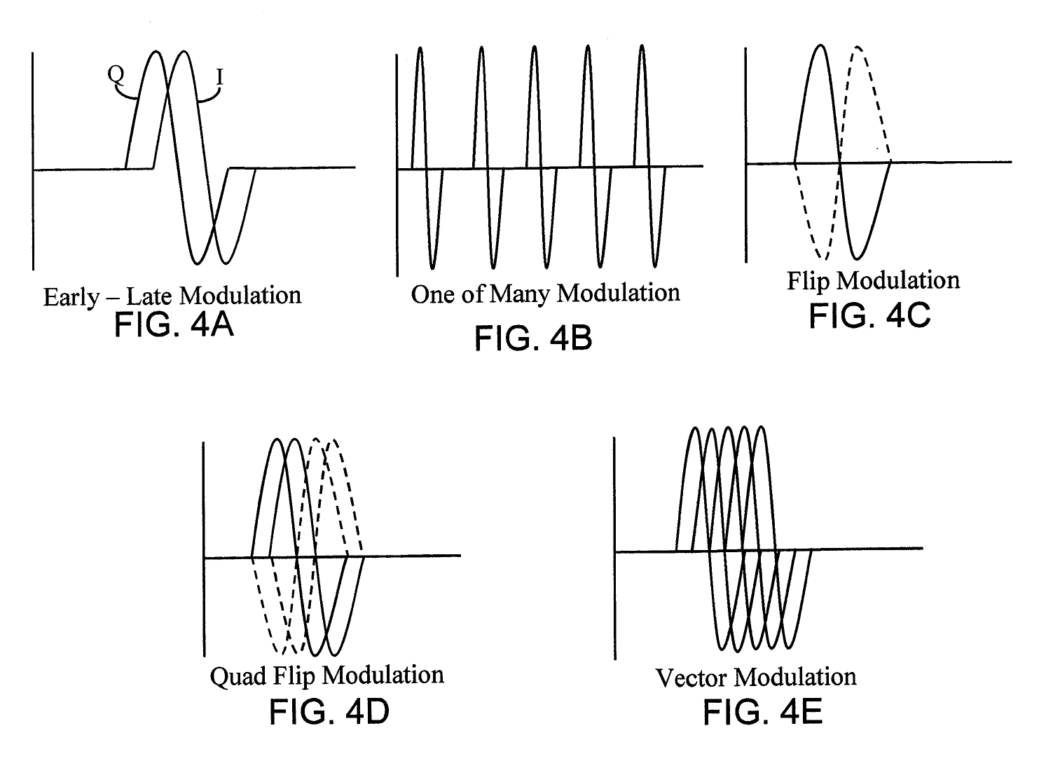

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A pulse train with conventional ‘early-late’ time-shift modulation can be expressed:

$${s}_{t r}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} - δ {d}_{ [ j / {N}_{s} ]}^{( k )} , {b}_{j}^{( k )} )$$

where k is the index of a transmitter, j is the index of a pulse within its pulse train, (−1) fⱼ^{(k)}, aⱼ^{(k)}, bⱼ^{(k)}, cⱼ^{(k)}, and ω(t,bⱼ^{(k)}) are the coded polarity, pulse amplitude, pulse type, pulse width, and normalized pulse waveform of the jth pulse of the kth transmitter, Tⱼ^{(k)} is the coded time shift of the jth pulse of the kth transmitter, δ is the time shift added when the transmitted symbol is 1 (instead of 0), d^{(k)} is the data (i.e., 0 or 1) transmitted by the kth transmitter, and Nₛ is the number of pulses per symbol (e.g., bit). Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, assigned to the assignee of the present invention, and incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, assigned to the assignee of the present invention, and incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, assigned to the assignee of the present invention, and incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they do not depend on receiving every transmitted pulse. Impulse radio receivers perform a correlating, synchronous receiving function (at the RF level) that uses statistical sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

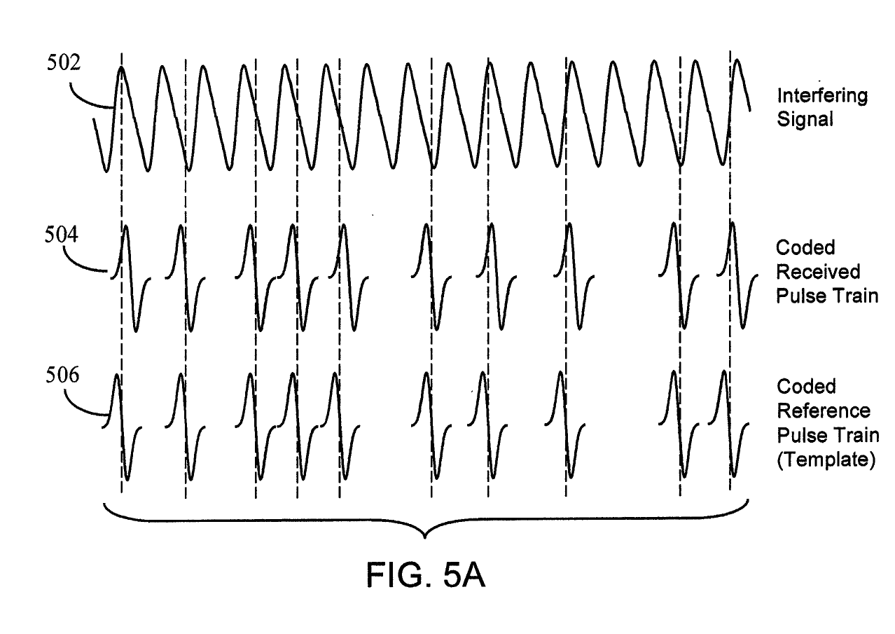

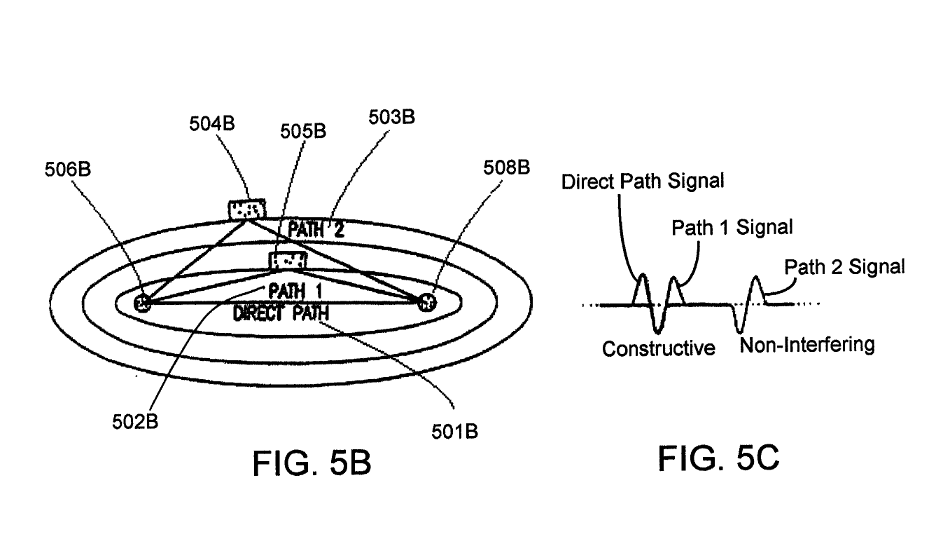

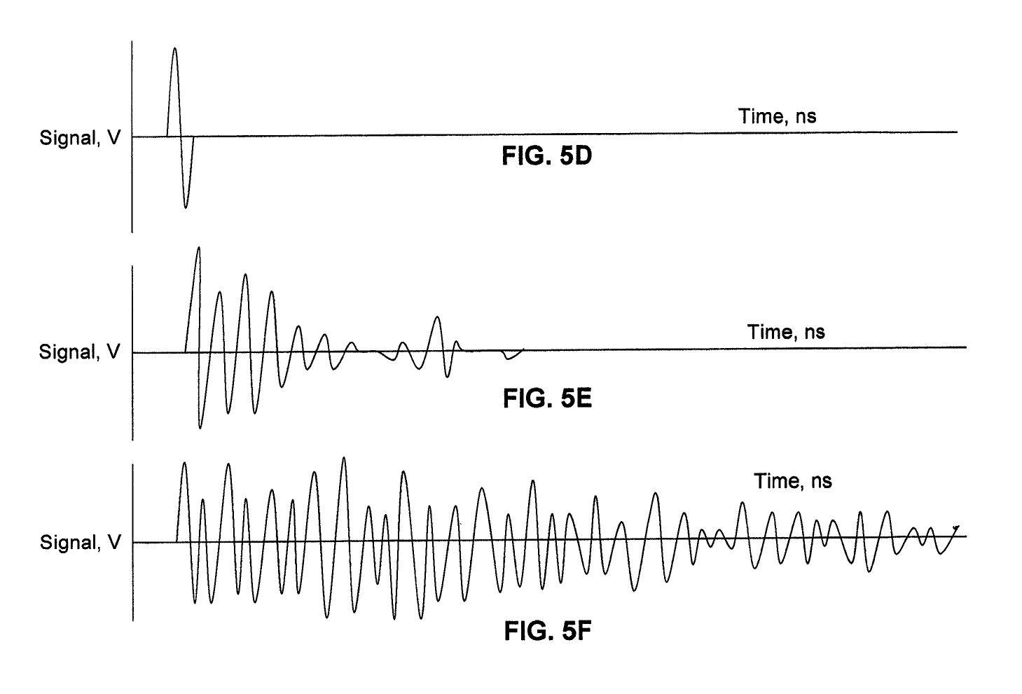

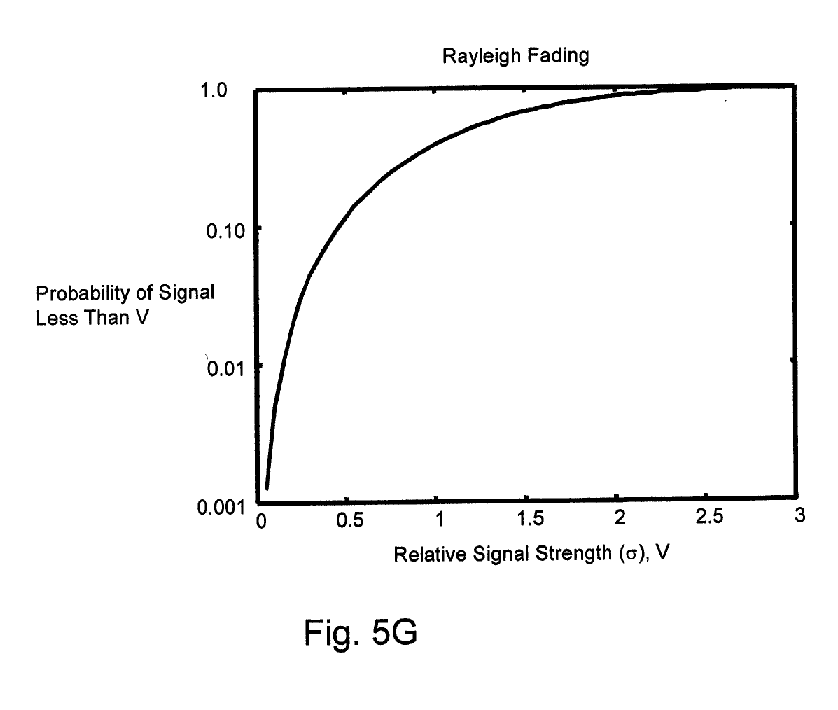

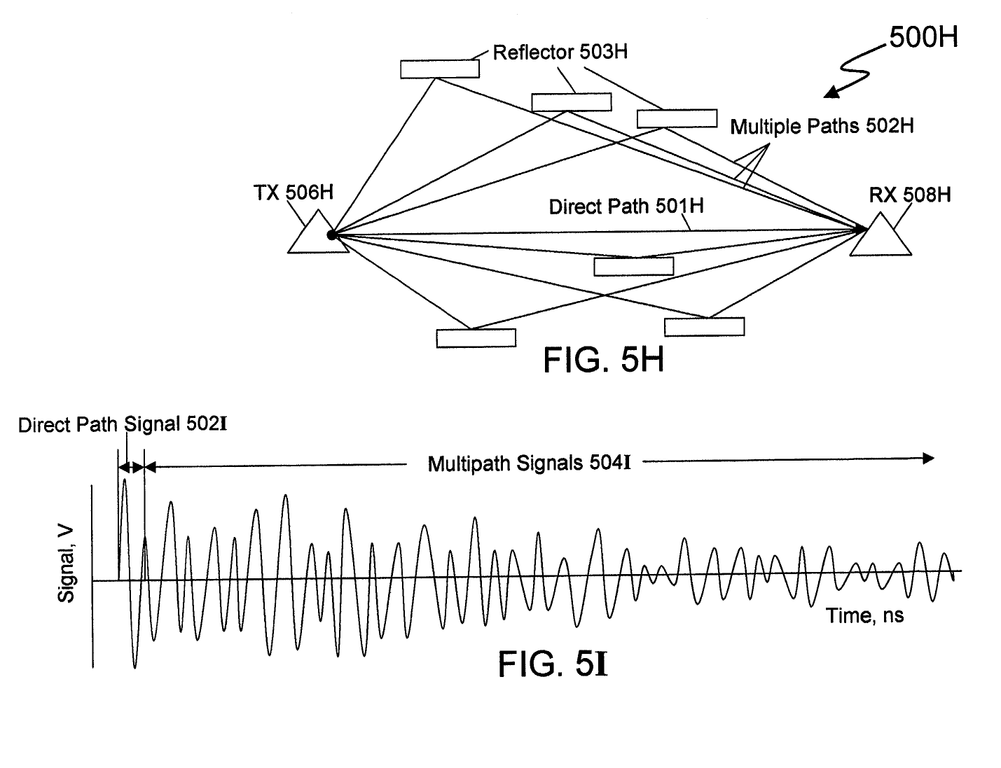

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems. FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000, or 30 dB. However, far greater processing gains are achieved by impulse radio systems, where the same 10 KHz information bandwidth is spread across a much greater 2 GHz channel bandwidth, resulting in a theoretical processing gain of 200,000, or 53 dB.

Capacity

It can be shown theoretically, using signal-to-noise arguments, that thousands of simultaneous channels are available to an impulse radio system as a result of its exceptional processing gain.

The average output signal-to-noise ratio of the impulse radio may be calculated for randomly selected time-hopping codes as a function of the number of active users, Nᵤ, as:

$$S N {R}_{out} ( {N}_{u} ) = \frac{{( {N}_{s} {A}_{1} {m}_{p} )}^{2}}{{σ}_{rec}^{2} + {N}_{s} {σ}_{a}^{2} {\sum }_{k = 2}^{{N}_{u}} {A}_{k}^{2}}$$

where Nₛ is the number of pulses integrated per bit of information, Aₖ models the attenuation of transmitter k's signal 2 over the propagation path to the receiver, and σ_{rec}² is the variance of the receiver noise component at the pulse train integrator output. The monocycle waveform-dependent parameters mₚ and σ_{α}² are given by

$${m}_{p} = {\int }_{- ∞}^{∞} ω ( t ) [ ω ( t ) - ω ( t - δ ) ] ⅆ t$$

$$and$$

$${σ}_{a}^{2} = {T}_{f}^{- 1} {\int }_{- ∞}^{∞} {[ {\int }_{- ∞}^{∞} ω ( t - s ) υ ( t ) ⅆ t ]}^{2} ⅆ s ,$$

where ω(t) is the monocycle waveform, ν(t)=ω(t)−ω(t−δ) is the template signal waveform, δ is the time shift between the monocycle waveform and the template signal waveform, T_{f} is the pulse repetition time, and s is signal.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents the majority of the potential coverage area of a radio system. In a mobile system, received signal strength fluctuates due to the changing mix of multipath signals that vary as its position varies relative to fixed transmitters, mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path2 503B, to receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of mulitipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

Where the system of FIG. 5B is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{r}{{σ}^{2}} exp ( \frac{- {r}^{2}}{2 {σ}^{2}} )$$

where r is the envelope amplitude of the combined multipath signals, and σ(2)^{½} is the RMS power of the combined multipath signals. The Rayleigh distribution curve in FIG. 5G shows that 10% of the time, the signal is more than 10 dB attenuated. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in an urban canyon or other situations where the propagation is such that the received signal is primarily scattered energy, impulse radio systems can avoid the Rayleigh fading mechanism that limits performance of narrow band systems, as illustrated in FIG. 5H and 5I. FIG. 5H depicts an impulse radio system in a high multipath environment 500H consisting of a transmitter 506H and a receiver 50H. A transmitted signal follows a direct path 501H and reflects off reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. In the same manner described earlier for FIGS. 5B and 5C, the direct path signal 502I is sampled, while the multipath signals 504I are not, resulting in Rayleigh fading avoidance.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has no multi-cycle ambiguity, it is possible to determine waveform position to less than a wavelength, potentially down to the noise floor of the system. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method is described in co-owned, co-pending application titled “System and Method for Person or Object Position Location Utilizing Impulse Radio,” Application No. 09/456,409, filed Dec. 8, 1999, and incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of impulse radio power control, see patent application titled “System and Method for Impulse Radio Power Control,” application Ser. No. 09/332,501, filed Jun. 14, 1999, assigned to the assignee of the present invention, and incorporated herein by reference.

Mitigating Effects of Interference

A method for mitigating interference in impulse radio systems comprises the steps of conveying the message in packets, repeating conveyance of selected packets to make up a repeat package, and conveying the repeat package a plurality of times at a repeat period greater than twice the period of occurrence of the interference. The communication may convey a message from a proximate transmitter to a distal receiver, and receive a message by a proximate receiver from a distal transmitter. In such a system, the method comprises the steps of providing interference indications by the distal receiver to the proximate transmitter, using the interference indications to determine predicted noise periods, and operating the proximate transmitter to convey the message according to at least one of the following: (1) avoiding conveying the message during noise periods, (2) conveying the message at a higher power during noise periods, (3) increasing error detection coding in the message during noise periods, (4) re-transmitting the message following noise periods, (5) avoiding conveying the message when interference is greater than a first strength, (6) conveying the message at a higher power when the interference is greater than a second strength, (7) increasing error detection coding in the message when the interference is greater than a third strength, and (8) re-transmitting a portion of the message after interference has subsided to less than a predetermined strength.

For greater elaboration of mitigating interference in impulse radio systems, see the patent application titled “Method for Mitigating Effects of Interference in Impulse Radio Communication,” Application No. 09/587,033, filed Jun. 02, 1999, assigned to the assignee of the present invention, and incorporated herein by reference.

Moderating Interference in Equipment Control Applications

Yet another improvement to impulse radio includes moderating interference with impulse radio wireless control of an appliance. The control is affected by a controller remote from the appliance which transmits impulse radio digital control signals to the appliance. The control signals have a transmission power and a data rate. The method comprises the steps of establishing a maximum acceptable noise value for a parameter relating to interfering signals and a frequency range for measuring the interfering signals, measuring the parameter for the interference signals within the frequency range, and effecting an alteration of transmission of the control signals when the parameter exceeds the maximum acceptable noise value.

For greater elaboration of moderating interference while effecting impulse radio wireless control of equipment, see patent application titled “Method and Apparatus for Moderating Interference While Effecting Impulse Radio Wireless Control of Equipment,” application Ser. No. 09/586,163, filed Jun. 2, 1999, and assigned to the assignee of the present invention, and incorporated herein by reference.

Exemplary Transceiver Implementation

Transmitter

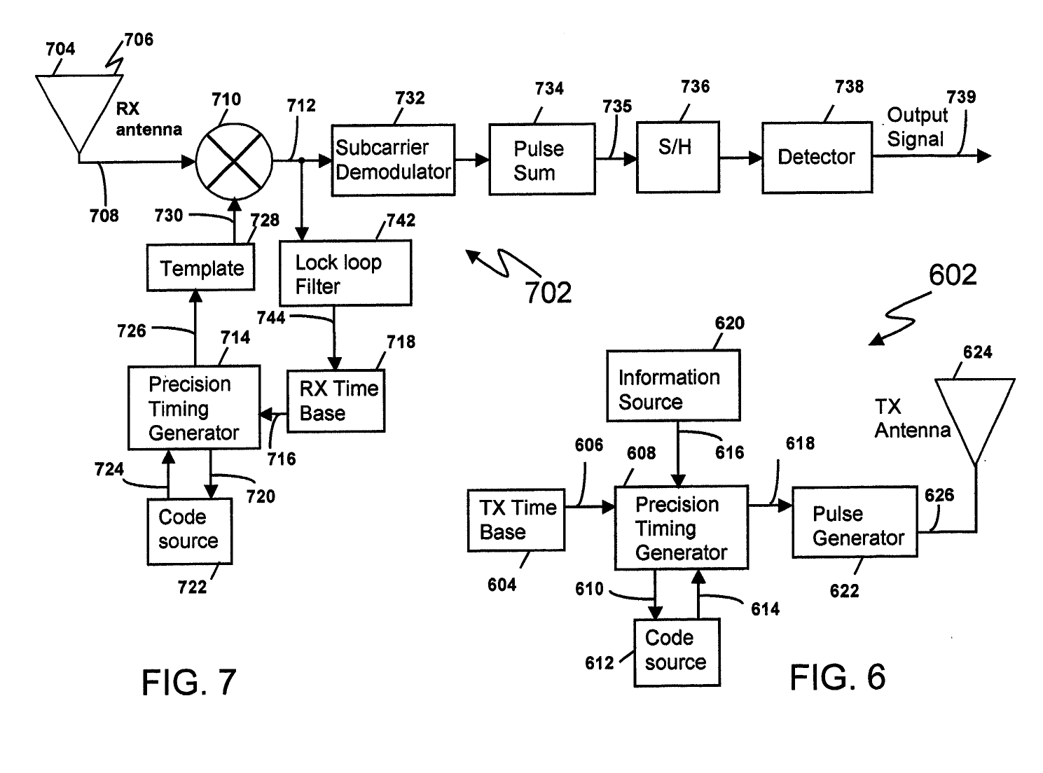

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses are called the emitted signal, and propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 is coupled to a subcarrier demodulator 732, which demodulates the subcarrier information signal from the optional subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to position in time the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

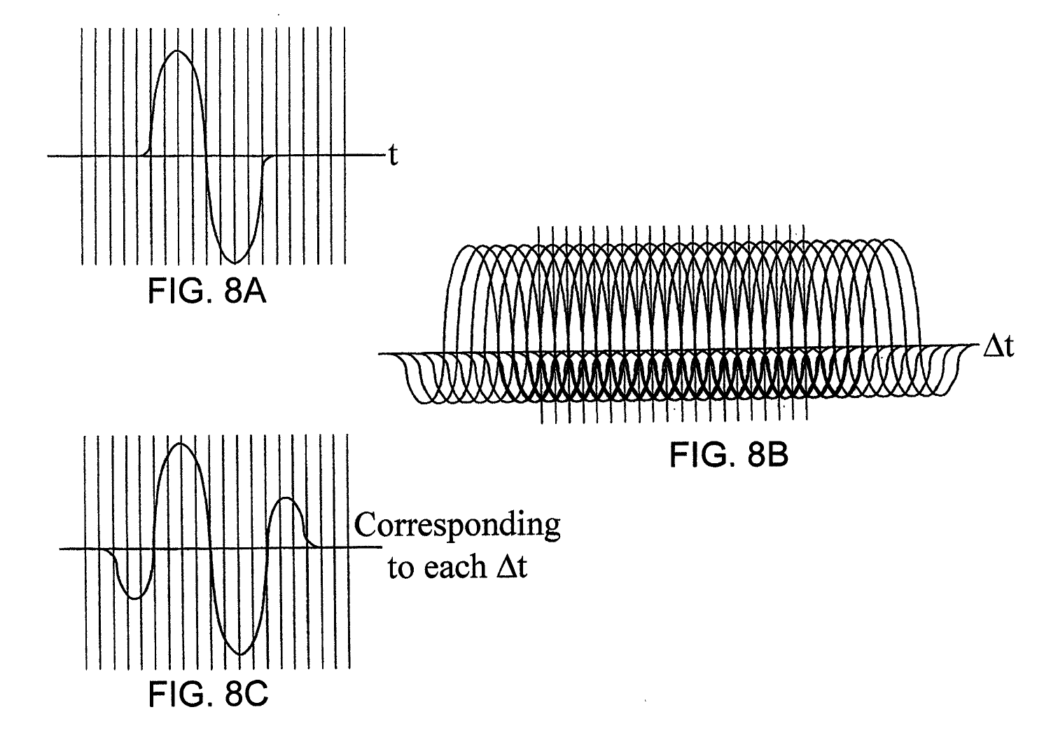

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927, and commonly owned co-pending application application Ser. No. 09/146,524, filed Sep. 3, 1998, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, assigned to the assignee of the present invention, and incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see the patent application titled “Method and System for Fast Acquisition of Ultra Wideband Signals,” application Ser. No. 09/538,292, filed Mar. 29, 2000, assigned to the assignee of the present invention, and incorporated herein by reference.

A receiver has been developed that includes a baseband signal converter device and combines multiple converter circuits and an RF amplifier in a single integrated circuit package. For greater elaboration of this receiver, see the patent application titled “Baseband Signal Converter for a Wideband Impulse Radio Receiver,” application Ser. No. 09/356,384, filed Jul. 16, 1999, assigned to the assignee of the present invention, and incorporated herein by reference.

### DESCRIPTION OF THE PREFERRED EMBODIMENTS

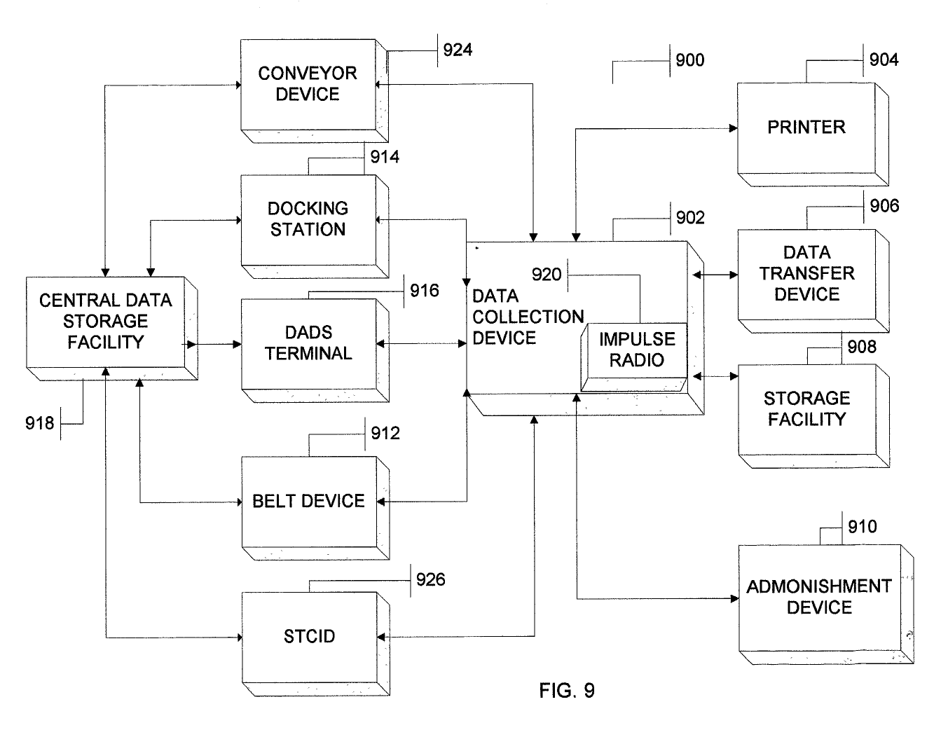

Embodiments of the present invention will now be described with reference to the drawings. FIG. 9 is a block diagram of the integrated data collection and transmission system of the present invention. As shown in FIG. 9, there are various components that make up the integrated system of the present invention. Central to the present invention is that the various components can communicate and share information via impulse radio techniques so that information collecting, processing, and storage can be effected as rapidly as possible so that device operations can be managed via an integrated, unitary system. In this way, users of the system and the ultimate customers can have prompt or even immediate access to information concerning major or all aspects of the package delivery system. Additionally, by integrating all of the components of the system, the information can be most efficiently stored, routed, and accessed by the users of the system.

As shown in the block diagram of FIG. 9, the integrated system 900 of the present invention includes a data collection device 902. The data collection device 902 is used to collect package information from customers and is generally used by couriers and other personnel. The data collection device 902 preferably has various input elements such as a bar code scanner, a keyboard, and/or a touch screen for the input of package data. Specific details of the data collection device 902 are described in greater detail below. The data collection device 902 also includes a CPU and a memory for storing data such as generic system information and/or collected package data as well as a means for communicating via impulse radio techniques between various of the other components of the integrated system 900. The data collection device 902 can include an impulse radio communications port 920 that can automatically transmit and receive impulse radio signals between the data collection device 902 and one or more peripheral devices whenever the data collection device 902 and the peripheral devices are within a preselected distance and/or within a preselected position. The data collection device 902 can even calculate the distance and position of the peripheral devices using impulse radios as described above and in the patents and patent applications incorporated herein by reference. In addition, the data collection device 902 can include a telephone communications port, such as a modem or an acoustic coupler, to allow for transmission of data over a telephone line or over a cellular phone system.

Via the impulse radio communications port 920, the data collection device 902 can communicate with one or more of a plurality of peripheral devices 904-910 and with one or more of a plurality of intermediate data storage devices 912-916 and 924-926. The peripheral devices 904-910, the details of which are described below, receive a communication via impulse radio means from the data collection device 902 and based on the receipt of the communication or the substance of that communication perform one or several operations related to package tracking. In the preferred application of integrated system 900, the data collection device 902 includes software such that it will automatically follow one or more preselected routines whenever it comes within a preselected distance and/or position from a peripheral device and is actuated, either by input of the user or by automatic communication with the peripheral device.

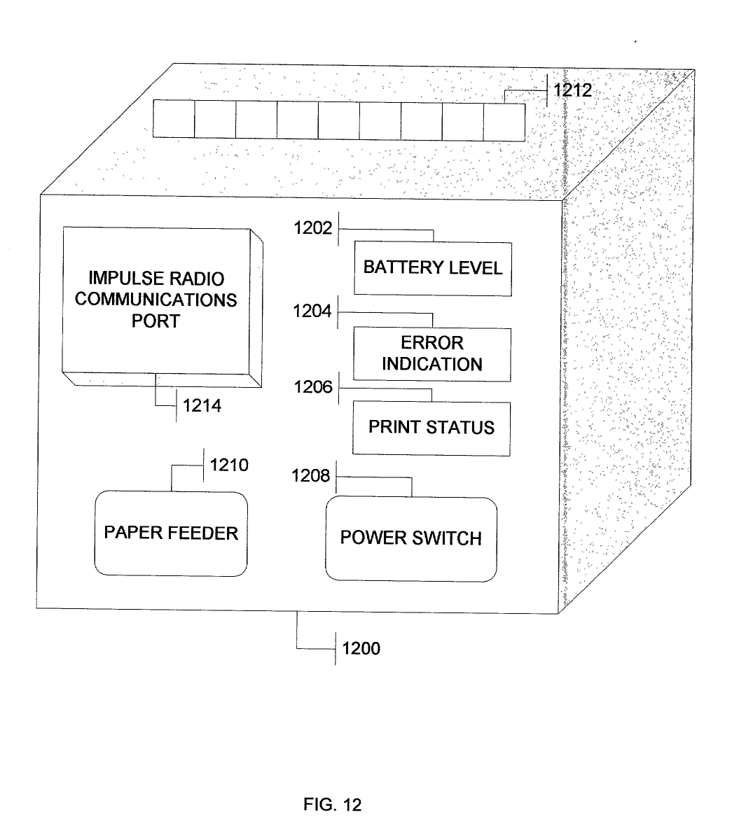

Similarly, in the preferred application of the device, such peripheral devices 904-910 includes a CPU and associated software such that the peripheral devices automatically follow one or more preselected routines, in response to the receipt of the communication, or in response to its review of the substance of the communication. Depending on the peripheral device 904-910, there can be a one-way or two-way communications link established between the data collection device 902 and that peripheral devices 904-910. If the peripheral device 904-910 is programmed to provide a communication to the data collection device 902, the substance of the communication is ultimately placed within its memory. Moreover, the data collection device 902 preferably follows one or more preseleted subroutines, based upon the receipt of the substance of the communication from peripheral device 904-910. The peripheral devices can include a printer 904, a data transfer device such as an impulse radio transceiver 906, a storage facility 908, and an admonishment device 910. Details of these peripheral devices are shown and described below with respect to FIGS. 12 through 15.

The data collection device 902 also communicates via impulse radio means with one or more of the intermediate storage devices 912-916 and 924-926. As shown in FIG. 9, in accordance with the present invention, as necessary, the intermediate storage device depicted as the belt device 912 can communicate with other of the intermediate storage devices such as the DADS terminal 916 via impulse radio means and with the central data storage facility 918. The intermediate storage devices 912-916 and 924-926 receive and store package information and, as appropriate, can transmit information or instructions to the data collection device 902.

As also shown in FIG. 9, the intermediate storage devices 912-916 and 924-926 communicate with a central data storage facility 918. The central data storage facility 918 acts as a warehouse for the package data and is accessible to provide information about the shipment of packages to customers and shipper personnel. For example, in the Federal Express package tracking system, the central data storage facility is known as COSMOS (Customer Operations Service Master On-line System). COSMOS is a sophisticated electronic network that tracks the status of every shipment in the Federal Express system. COSMOS connects the physical handling of packages and related information to the major data systems at Federal Express and, in turn, with customers and employees. Although for exemplification the Federal Express system is described, it is understood that the use of impulse radios to enhance the capabilities of the wireless communication between devices within a package tracking system can be extended to systems employed by other entities wherein tracking packages is critical such as the United Parcel Service system.

Primary to the integrated system of the present invention is the data collection device 902, which is used primarily to collect and store information about packages to be shipped. However, in accordance with the present invention, the data collection device 902 is also capable of performing other, secondary, functions related to package delivery via communications with one or more of the peripheral devices 904-910.

The data collection device 902 can take several forms, but for description purpose the Federal Express system will be utilized which will generally fall into two categories, the enhanced Supertracker (EST) and the Power Pad. The Supertracker is a relatively small, battery powered device used by Federal Express personnel for collecting data relative to packages to be shipped. The Supertracker includes an alphanumeric keyboard and a contact bar code scanner to collect information. It also includes a CPU and a memory. The collected information is stored in the memory and can be communicated to an intermediate storage device via impulse radio means. Previously, when information is transferred via an LED (the prior art method used by Federal Express), the Supertracker had to be physically in contact with the device with which it communicates. However, while using impulse radio communication techniques in lieu of an LED no such physical contact is required.

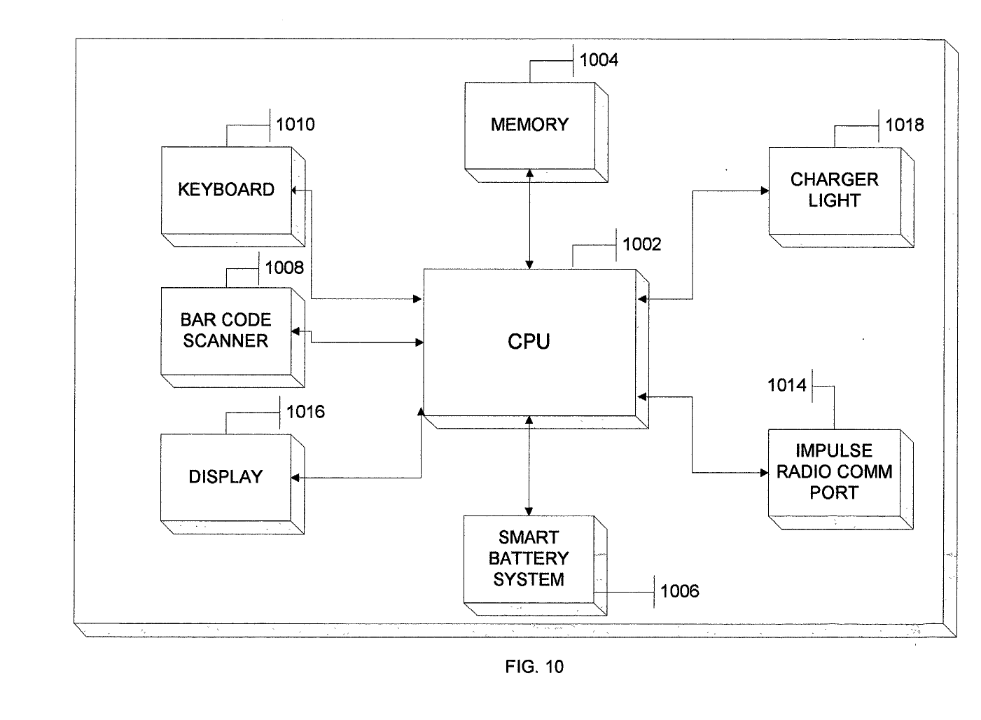

FIG. 10 is a block diagram of an EST. As shown in FIG. 10, for package data collection, the EST 1000 includes a keyboard 1010, coupled to CPU 1002. Keyboard 1010 includes a full array of alphanumeric buttons. Preferably, the keyboard 1010 glows in the dark to enhance usability. EST 1000 also includes a display 1016, which is preferably a liquid crystal display (LCD) Display 1016 is preferably mounted within the EST 1000 by a series of display floats, which are essentially like foam doughnuts, to prevent shock to the EST 1000 from being transferred to display 1016 or from display 1016 to keyboard 1010. EST 1000 also includes a bar code scanner 1008, which may comprise one or more of a contact bar code scanner, a non-contact laser scanner, and a CCD, which is also coupled to CPU 1002. Specifics on using impulse radio integrated into a bar code scanner is fully described in patent application Ser. No. 09/767,244, entitled “Hand-Held Scanner with Impulse Radio Wireless Interface” which is incorporated herein by reference and assigned to the assignee of the present invention.

Data input via keyboard 1010 and bar code scanner 1008 is stored in memory 1004, which preferably comprises several 16 Mbit flash memory chips, though the number and configuration of the memory elements is within the purview of one of ordinary skill in the art.

EST 1000 also includes a smart battery system 1006. The smart battery system 1006 comprises the primary power source of the EST 1000, which is a pack preferably consisting of two AA NiCad batteries surrounded by a plastic strap. The smart battery system 1006 is also preferably capable of providing information about battery usage and power level to the user. The smart battery system 1006 preferably comprises a connector and an EEPROM mounted on a small circuit board to permit the EST 1000 to store timely information about the energy capacity of the batteries, the number of times the pack has been charged and discharged, the temperature of the batteries, the history of the batteries, a requirement for a deep cycle, and a requirement for recycling. This information can be output to the user via display 1016. For example, display 1016 can include a fuel gauge that graphically represents to the user the relative amount of battery power left in the batteries. In addition, the EST 1000 output via display 1016 instructions regarding requirements for deep cycling and recycling the batteries.

The smart battery system 1006 also preferably periodically determines the power consumed by the EST 1000 and controls at least one of the output or operation of the EST 1000 based on that determination. For example, if the smart battery system 1006 determines that the battery power of the EST 1000 is about to expire, that is that the power level of the batteries is at a preselected level, the smart battery system 1006 will instruct the CPU 1002 to shut down the device or vary the duty cycle of the impulse radio communications as described above and in the patents and patent applications incorporated herein by reference. In accordance with this operation, the user can be provided with a visual or audio alert advising him that the EST 1000 is about to cease operating.

The smart battery system 1006 also controls the recharging of the batteries, based on a determination of the power consumption of the device. That is, if little power has been consumed, the smart battery system will control the battery recharge operation so that the batteries are not excessively recharged. This extends the useful life of the batteries. In addition, the EST 1000 includes a charger light 1018 that provides a visual indication when the EST 1000 is being charged.

The EST 1000 also includes an impulse radio communications port 1014, which permits impulse radio communications with other devices of the integrated system 900. The impulse radio communications port 1014 preferably comprises an impulse radio interface in communication with an impulse radio transceiver. A complete description of the use of impulse radios in data communication is described above and in the patents and patent applications incorporated herein by reference. In the novel impulse radio communication techniques herein described, now a package courier such as Federal Express can use impulse radios to transmit over the courier area network. In accordance with the present invention, an impulse radio can be employed, which communicates over a maximum distance of, for example, approximately 50 feet. Again, this distance can be determined using impulse radio techniques.

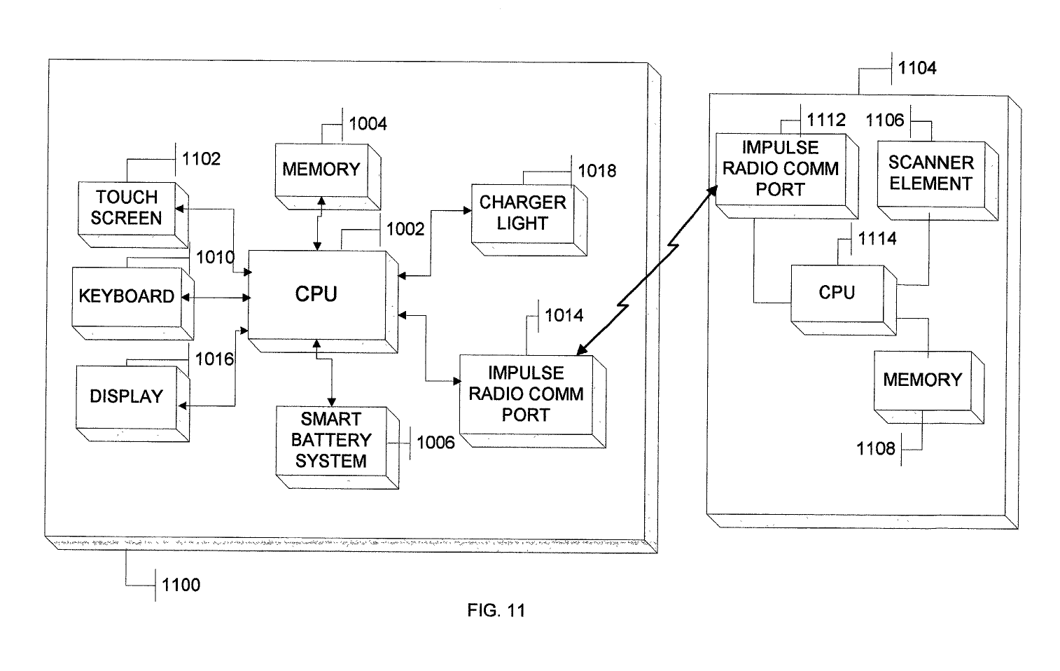

As indicated above, data collection device 902 can also preferably comprise a Power Pad. FIG. 11 is a block diagram of the Power Pad 1100. The Power Pad 1100 includes many of the same components as the EST 1000, the common elements of FIGS. 10 and 11 being labeled with the same reference numerals. In addition, the Power Pad includes a touch screen 1102. The touch screen 1102 can be used with a stylus (not shown) to input package information. In addition, the touch screen can be used to capture signature information of a person sending a package or signing for a received package. Power Pad 1100 can also be used to receive, store, and display, as necessary, dispatch information for a particular courier. In addition, Power Pad 1100 can be used as a courier notebook, thereby allowing a courier to enter and maintain notes and information about his route and associated operations. Power Pad 1100 can also store and maintain maps, dangerous goods information, international delivery information, news updates, the service reference guide, zip codes, and a cash-only customer list, as well as other information that may be useful for the courier. In addition, the Power Pad 1100 can provide instructions to the courier based on their level of experience, can provide performance feedback to the courier, and can provide address verification.

The bar code scanner 1104 of the Power Pad 1100 is preferably not integral to the device, but rather is a physically separate item. For example, the bar code scanner 1104 preferably comprises a scanning device in the shape of a large ball point pen. Bar code scanner 1104 preferably comprises a scanning element 1106, which may include one or more of a contact scanner, a non-contact laser scanner and a CCD, a memory 1108, and an impulse radio communications port 1112. These components are controlled by a CPU 1114. As shown in FIG. 11, the impulse radio communications port 1112 of bar code scanner 1104 communicate with the impulse radio communications port 1014 using impulse radio signals. Bar code data collected by bar code scanner 1104 is thus transferred to memory 1004. It is understood that the keyboard 1010 of the Power Pad 1100 can be implemented as a part of the touch screen 1102 or can be a separate element. This is also true with respect to the charger light 1018.

The EST 1000 and the Power Pad 1100 can communicate with one or more of a plurality of peripheral devices 904-910. One such peripheral device is a printer 904. FIG. 12 is a schematic diagram of a printer that may be used in accordance with the present invention.

The printer 1200, shown in FIG. 12, is preferably a portable device that can be carried by a courier using a shoulder strap (not shown), though a stand-alone, non-portable printer can also be used in accordance with the present invention. The printer 1200 is preferably used in conjunction with data collection device 902 to print shipping labels or other required paperwork. Printer 1200 includes various LEDs 1202-1206 indicating, respectively, battery level 1202, an error indication 1204, and print status 1206. In addition, the printer includes a power switch 1208 and a feed button 1210 to feed paper through paper feeder 1212. The printer 1200 also preferably includes an impulse radio communications port 1214 capable of receiving information from the data collection terminal 902. Impulse radio communications port 1214 preferably comprises an impulse radio interface and an impulse radio transceiver. Printer 1200 also includes a memory and a CPU for processing, and storing information from data collection device 902 input through the impulse radio communications port 1214.

In operation, if the user of the data collection terminal 902 wants to print, for example, a label or a receipt, he will enter a print command into, for example, the keyboard of data collection terminal 902. The impulse radio communications port of the data collection device 902 will communicate this information to the impulse radio communications port 1214 via impulse radio communications interface (not shown) of the printer 1200 and a label or other appropriate document will be printed. The printer 1200 preferably is always in a receive ready state. Using distance determination techniques of impulse radio, it can be required that the two devices be within a predetermined distance of one another.

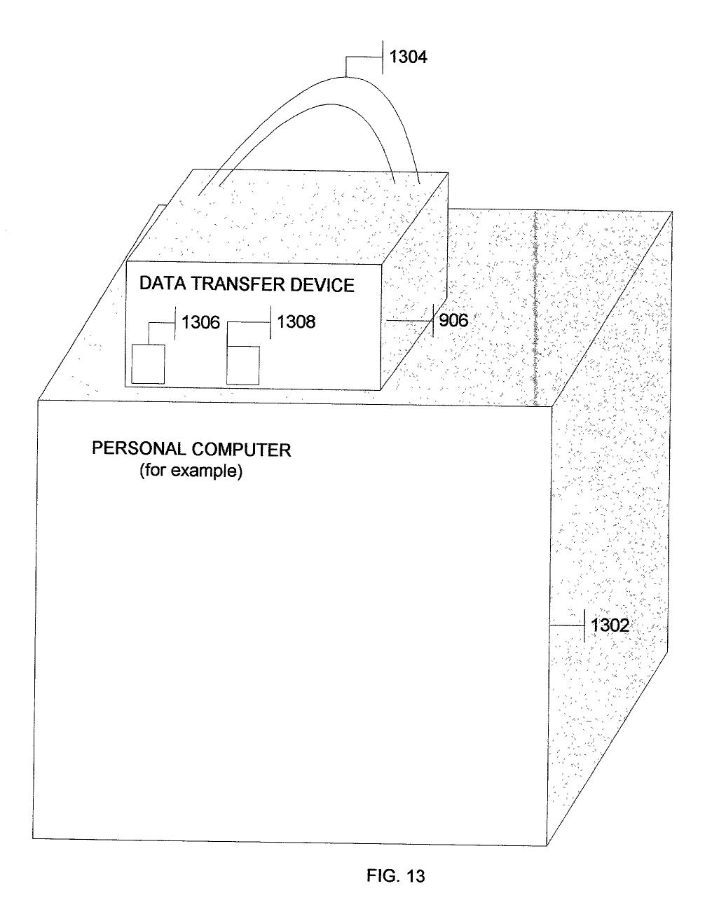

Another peripheral device that can receive communications from the data collection device is a data transfer device 906. FIG. 13 is a schematic diagram of a data transfer device in accordance with the present invention. The data transfer device 906 in accordance with the present invention is used to communicate information from, for example, a customer's personal computer (PC) to a data collection device 902. For example, information about package tracking entered by the customer using the Federal Express POWERSHIP PASSPORT.®. system or other appropriate system can be transmitted to the data collection device 902 via the data transfer device 906.

As shown in FIG. 13, the data transfer device 906 is coupled to customer PC 1302 via a cable 1304, although impulse radio techniques can be used instead of the cable. The data transfer device 906 includes an impulse radio communications port 1306 for communication with the data collection terminal 902. In addition, the data transfer device 906 includes associated control circuitry and buffer memory needed to receive and send data from the PC 1302 to the data collection device 902. In addition, the PC 1302 and the data collection device 902 include the software required for the devices to communicate via the data transfer device 906.

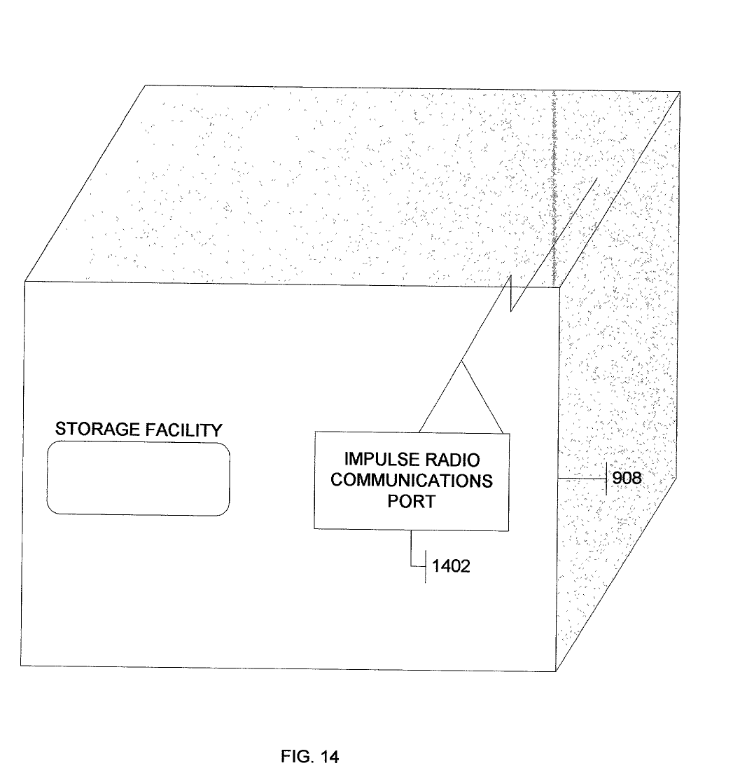

Another peripheral device that is capable of receiving communications from the data collection device 902 is storage facility 908. FIG. 14 is a schematic diagram of a storage facility in accordance with the present invention. In a preferred implementation, storage facility 908 is a drop box, where customers can leave packages for subsequent pick-up by Federal Express personnel or the personnel of the shipping entity wherein the present invention is utilized. In accordance with the present invention, the storage facility 908 can be fitted with an impulse radio communications port 1402 comprising an impulse radio interface and an impulse radio transceiver. If existing infrastructure currently use microradio or another wireless technique, an impulse radio can be used in cooperation with the preexisting wireless device. By so equipping the storage facility, the courier can open the storage facility without requiring the use of a key. For example, when a communication is received by the port 1402 associated with the storage facility 908, the lock on the facility would be opened. This eases operations for the courier and enhances the security of remote storage areas. Similarly, in accordance with the present invention, other devices can be provided with a communications port to enable keyless entry via a courier (or other) personnel using their data collection device 902.

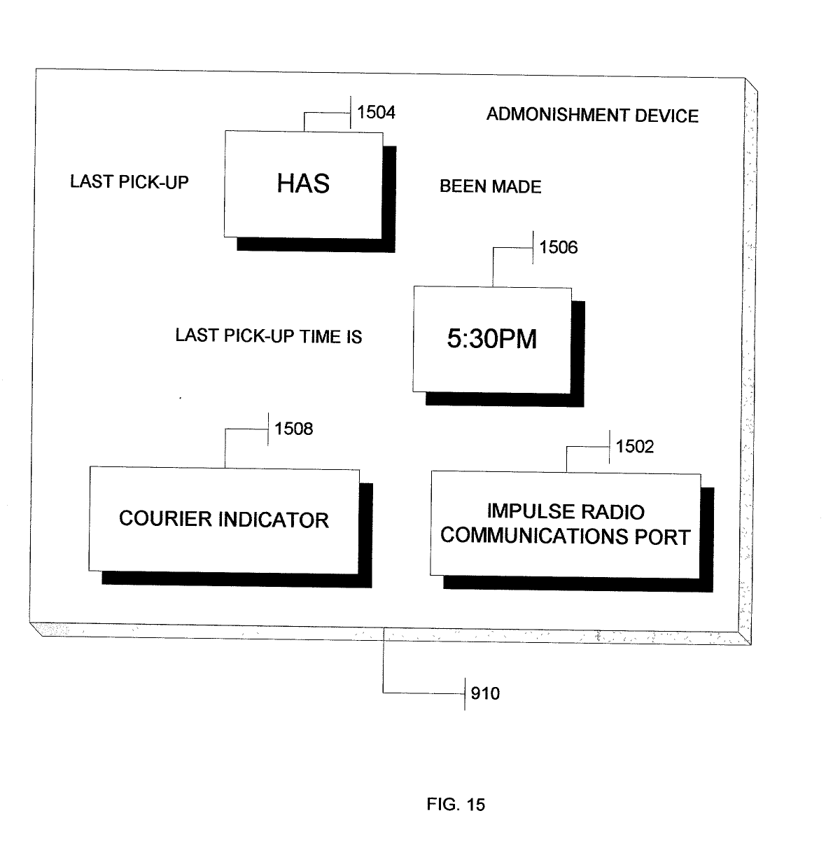

Yet another peripheral device that is capable of receiving communications from the data collection device 902 is admonishment device 910. FIG. 15 is a schematic diagram of an admonishment device in accordance with the present invention. Admonishment device 910 preferably advises customers whether package pick-up from a particular storage facility, or drop box, has been made and is preferably physically attached to the storage facility. Admonishment device 910 includes an impulse radio communications port 1502, which includes an impulse radio transceiver and impulse radio interface. Via impulse radio communications port 1502, the admonishment device 910 can receive information from a data collection device 902. For example, a courier can set a pick-up indicator 1508 via remote communication from his data collection device 902 through impulse radio communications port 1502 to indicate that the last pick-up of the day has occurred. In that way a later arriving customer will know not to leave a package if they want it picked up that day. In addition, the data collection device 902 can provide information to a time indicator 1506 to set the time of the last pick-up. This time can vary depending on the day of the week and the weather conditions, for example. In this way customers can be advised of the last time for package pick-up and can plan their actions accordingly. Alternatively, or in addition, admonishment device 910 can include a courier indicator 1508 advising the courier whether there are any packages in the drop box for pickup. Courier indicator 1508 preferably comprises a visual display advising the courier whether there are any packages in the storage facility that need to be picked up.

It is also contemplated that in accordance with the present invention, the admonishment device 910 can send a communication to the data collection device 902 advising the courier whether there are any packages in a particular storage facility. Such a communication would preferably be sent via impulse radio communications port 1502. By receiving such a communication the courier would avoid having to physically check the storage facility if there are no packages there. It is also contemplated that admonishment device 910 could communicate the status of the storage facility to a central dispatch station, which could then dispatch such information to the data collection device 902 of the courier responsible for the particular storage facility.

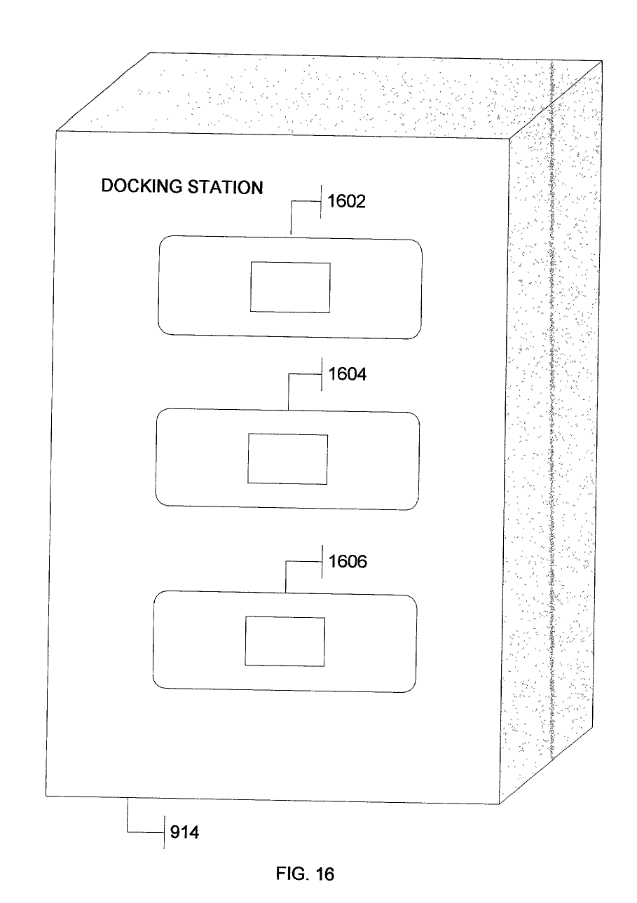

As explained above, the data collection device 902 is capable of communicating with one or more intermediate storage devices 912-916 and 924-926, which are described below with reference to FIGS. 16-20. One of the intermediate storage devices is a docking station 914. FIG. 16 is a schematic diagram of a docking station in accordance with the present invention. Docking station 914 is preferably located at a central shipping location, for example, where the courier goes to unload or pickup packages. The docking station 914 preferably comprises a number of ports 1602-1606, each of which are capable of receiving a data collection device 902. The data stored in the data collection device 902 is transmitted to a data storage device in the docking station 914, which subsequently transmits the data to the central data storage facility 918. Alternatively, it is possible to avoid having to dock the docking station 914 and the data collection device 902, by simply using impulse radio distance determination techniques and wirelessly transmitting all of the information needed to the intermediate storage device 914 when the data collection device 902 is a predetermined distance from the storage device 914.

Docking station 914 is used, for example, at the end of a courier's shift to transmit all previously collected data, ultimately to the central data storage facility 918. Selected portions or all of the memory of the data collection device 902 can then be erased and the data collection device will be ready for additional data collection. In addition, the docking station 914 can receive communications from the central data storage facility 918 for transmission to the data collection device 902. For example, the docking station 914 and the central data storage facility 918 can communicate using impulse radio wireless means to transfer update software or other information related to package tracking, for instance, updated postal codes. Docking station 914 is also preferably used for recharging the batteries of data collection device 902.

Another intermediate storage device used in the system in accordance with the present invention and in the Federal Express case is DADS (Digitally Assisted Dispatch System) terminal 916 or any similar system in the case of another package delivery service. The DADS (Digitally Assisted Dispatch System) system is the Federal Express nationwide electronic dispatch network, which utilizes a number of DADS terminals. Typically, the DADS terminal is located within the courier vehicle, though the DADS terminal could also be portable and be carried in a backpack by the courier. Previously, after package data was collected by the data collection device 902 at a customer site, the data collection device 902 was placed into a “shoe” in the DADS terminal. In the present embodiment, the DADS terminal would thus upload the data from the data collection device 902 to the central data storage facility 918, via impulse radio means.

In accordance with the present invention and by using impulse radio, physical contact between the DADS terminal and the data collection device 902 is unnecessary for data transfer between the devices to occur. As a result, information about package delivery can be made available at the central data storage facility 918, and hence to the customer, much more quickly and easily. In accordance with the present invention, once the data collection device 902 is within a predetermined distance of the DADS terminal 916, the data collection device 902 will automatically transmit data to the DADS terminal. In the alternative, the user can initiate the communication by physically activating a key or otherwise inputting an instruction to the data collection device 902.

Preferably, the DADS terminal will also substantially transfer data or instructions to the data collection device 902, for example, in response to a communication from data collection device 902 or upon receipt of a preselected command or data input. In an alternate embodiment, the data collection device 902 can be manually actuated to permit such communication. In either event, such communication avoids having to physically connect the data collection terminal 902 and the DADS terminal for information transmission.

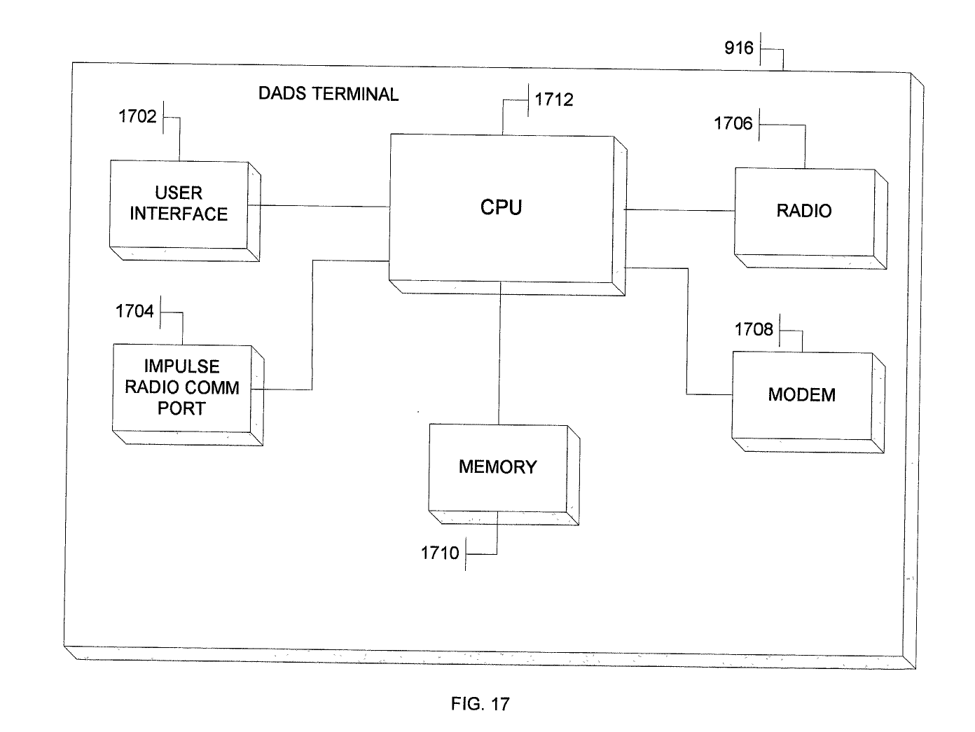

FIG. 17 is a block diagram of a DADS terminal in accordance with the present invention. The DADS terminal 916 preferably includes a user interface 1702, which includes, generally a keyboard for data entry and a screen to display information input via the keyboard and to display information transmitted from the central data storage facility 918, or other remote source such as a dispatching station. The screen can also display information about the status of information received from the data collection device 902. User interface 1702 can be integral with the remainder of the components of DADS terminal 916 or can be separate from them. In accordance with the present invention, it is contemplated that the user interface 916 can be separately mounted in the courier vehicle, for example on a swivel mount, while the remainder of the components can be situated elsewhere in the courier vehicle.

DADS terminal 916 also includes an impulse radio communications port 1704 for receiving information from the data collection device 902. In addition, DADS terminal 916 also preferably includes a radio 1706, which is a relatively high-powered radio, and a modem 1708 for communicating data stored in memory 1710 to the central data storage facility 918. It is contemplated that radio 1706 and modem 1708 can be integrated into a single unit, as desired. Operation of DADS terminal 916 is controlled by CPU 1712 and/or command inputs from the user.

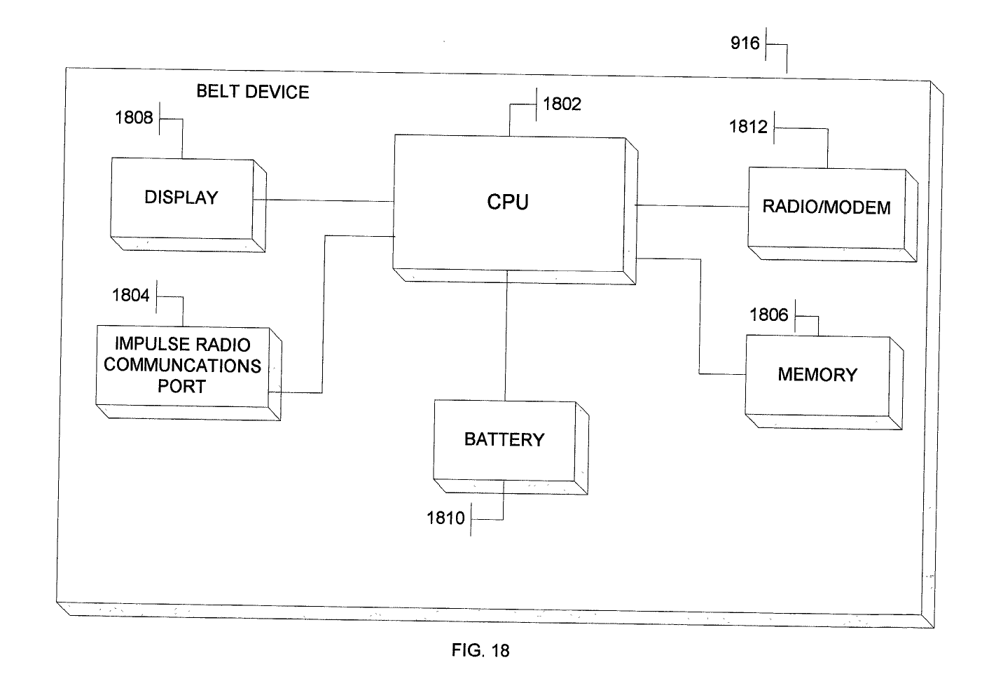

Another intermediate storage device is belt device 912. FIG. 18 is a block diagram of a belt device in accordance with the present invention. The belt device 912 of the present invention is preferably body wearable and may, as the name implies be attached to the user's belt. Of course the belt device 912 could be attached elsewhere on the user's body. Preferably belt device 912 is fairly small, about twice the size of a typical pager, and will not impede normal courier activities.

Belt device 912 is used in conjunction with a data collection device 902 and provides for almost real-time transmission of package data to either central data storage facility 918 or DADS terminal 916. Belt device 912 will typically be used in situations where transmission of package data between the data collection device 902 and central data storage facility 918 or DADS terminal 916 will be delayed because the courier will not be returning to his vehicle for some time to transmit the collected information. This may occur in high density areas where the courier will, for example, spend a good deal of time in a single building collecting and/or delivering packages. By using the belt device 912, package information can be transmitted to the either the central data storage facility 918 or DADS terminal 916 before the courier is within the predetermined distance requirement for impulse radio communications required by the data collection device 902. In this way the package shipper can fulfill its commitment to providing its customers access to information about their packages within a predetermined time.

Belt device 912 receives package information from the data collection device 902 via the communications port 1804. The information is then stored in a memory 1806, which is preferably a buffer memory. At predetermined intervals and under the control of CPU 1802, powered by battery 1810, a radio/modem 1812 transmits the stored information to central data storage facility 918 or to another intermediate storage device, such as DADS terminal 916. Radio/modem 1812 preferably comprises a medium range radio that can transmit within, for example, a five mile range. Optionally, the belt device 912 can also include a display 1808 that can output, for example, status information to the user. Display 1808 can be a screen or a series of LEDs, for example.

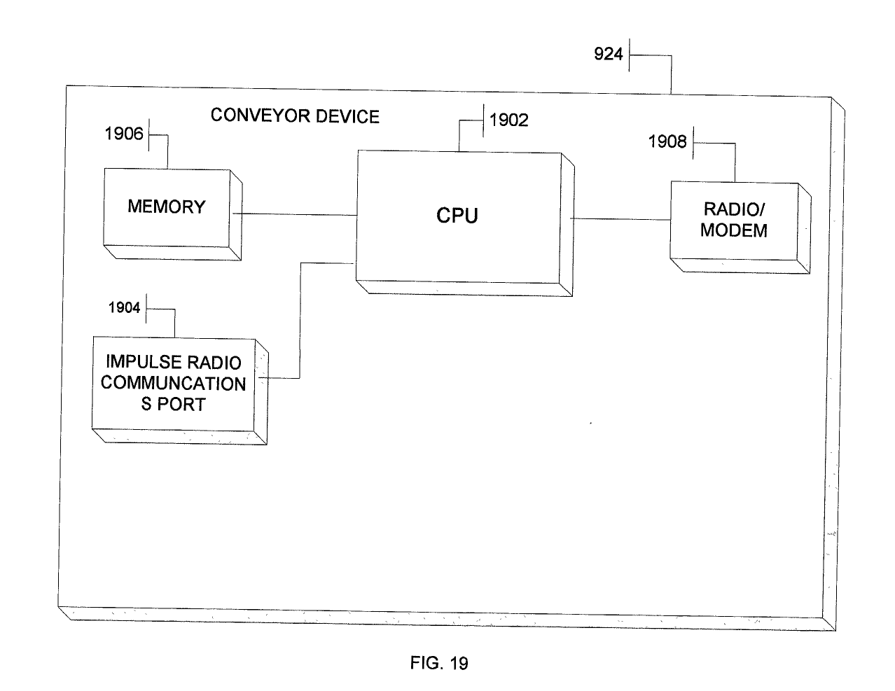

Another intermediate storage device is conveyor device 924. FIG. 19 is a block diagram of a conveyor device according to the present invention. Conveyor device 924 is preferably connected to a conveyor belt that is located in a hub location where for example package delivery vehicles transfer packages. Couriers or other package delivery personnel scan packages with a data collection device 902 when the packages are transmitted along a conveyor belt. The information collected by the data collection device is then preferably transmitted to conveyor device 924, which stores the package information and transmits it to the central data storage facility 918. In this way the central data storage facility 918 receives virtually real-time information about the status of packages while in transit.

Conveyor device 924 includes an impulse radio communications port 1904, which comprises and impulse radio interface and an impulse radio transceiver, which receives information from data collection device 902. The information is stored in a memory 1906, which is preferably a buffer memory and is then transmitted to central data storage facility 918 via radio 1908, which is preferably a medium range radio capable of transmitting in a range of, for example, five miles. Operation of conveyor device 924 is controlled via CPU 1902.

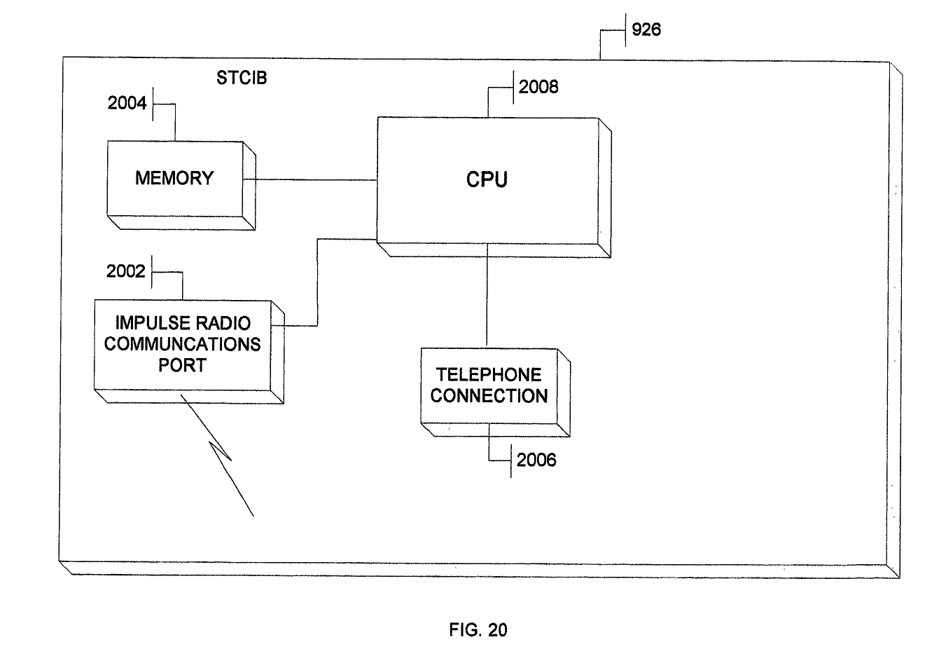

Yet another intermediate storage device is a Supertracker Communication Interface Device (STCID) 926. FIG. 20 is a block diagram of an STCID in accordance with the present invention. STCID 926 enables communications from a data collection device 902 directly to central data storage facility 918 over, for example, a pay telephone. STCID 926 includes an impulse radio communications port 2002, which preferably includes an impulse radio interface in communication with an impulse radio transceiver and which receives information from a data collection device 902. The information is stored in a memory 2004. When it is desired to transmit the stored information, the STCID 926 is coupled to the receiver of a telephone via telephone connection 2006. In a preferred embodiment of the present invention, the STCID is approximately the size of a flip-phone and the telephone connection 2006 includes elements, preferably in the form of cups, that fit over the speaker and microphone cups of the telephone to which the STCID 926 is connected. Receipt, storage, and transmission of information via STCID 926 is controlled by CPU 2008.

As described above and shown in the associated drawings, the present invention comprises an integrated system and method for the collection and transmission of data related to package delivery using impulse radios as an integral part. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

What Is claimed Is:

1. An impulse radio integrated data collection and transmission system for package tracking comprising:
a data collection terminal capable of collecting and storing package tracking data, the data collection terminal including an impulse radio communications port;
at least one peripheral device, associated with the data collection terminal, said at least one peripheral device including an impulse radio communications port for receiving at least one communication from the data collection terminal and for performing a preselected operation related to package tracking based on said at least one received communication;
an intermediate data storage device, associated with the data collection terminal, the intermediate data storage device including an impulse radio communications port for receiving the collected and stored package tracking data from the data collection terminal; and
a central data collection facility, capable of communicating with the intermediate data storage device, for receiving the collected and stored package tracking data from the intermediate data storage device and for maintaining an accessible package tracking database based on the collected and stored package tracking data.

2. The integrated data collection and transmission system for package tracking as recited in claim 1, wherein communication between said data collection terminal and said at least one peripheral device occurs automatically.

3. The integrated data collection and transmission system for package tracking as recited in claim 2, wherein said automatic communication occurs by distance determination techniques using impulse radios and wherein said automatic communication occurs at a predetermined distance.

4. The integrated data collection and transmission system for package tracking as recited in claim 1, wherein communication between the data collection terminal and the at least one peripheral device is activated by a user of the data collection terminal.

5. The integrated data collection and transmission system for package tracking as recited in claim 1, wherein the at least one impulse radio communication is a set of instructions.

6. The integrated data collection and transmission system for package tracking as recited in claim 1, wherein the at least one peripheral device comprises a printer and wherein said preselected operation includes printing one of a label containing package tracking information and a receipt.

7. The integrated data collection and transmission system for package tracking as recited in claim 1, wherein said at least one peripheral device comprises a data transfer device coupled to a customer PC and wherein the preselected operation comprises transmitting package tracking information from the customer PC to the data collection terminal via an impulse radio communications port using impulse radio communications.

8. The integrated data collection and transmission system for package tracking as recited in claim 1, wherein said at least one peripheral device comprises a storage facility having controlled access and wherein said preselected operation includes providing access to said storage facility.

9. The integrated data collection and transmission system for package tracking as recited in claim 1, wherein said at least one peripheral device comprises an admonishment device capable of advising a courier of the contents of a storage facility.

10. The integrated data collection and transmission system for package tracking as recited in claim 1, wherein said at least one peripheral device comprises a keyless entry device and wherein said preselected operation comprises opening a door of one of a package delivery vehicle and a package sorting facility.

11. The integrated data collection and transmission system for package tracking as recited in claim 1, wherein said intermediate data storage device comprises a vehicle mounted data terminal for receiving the collected and stored package tracking data from the data collection terminal and for forwarding the data to the central data collection facility and for receiving dispatch information.

12. The integrated data collection and transmission system for package tracking as recited in claim 1, wherein said intermediate data storage device comprises a portable data terminal for receiving the collected and stored package tracking data from the data collection terminal and for forwarding the data to the central data collection facility and for receiving dispatch information.

13. The integrated data collection and transmission system for package tracking as recited in claim 1, wherein said data collection terminal includes a battery supply and a system to determine the relative power capacity of the battery power supply and stored information representative of the battery power supply and wherein the data reception device recharges the battery power supply in response to the stored information representative of the battery power supply when the data collection terminal is placed in the data reception device.

14. The integrated data collection and transmission system for package tracking as recited in claim 1, wherein said intermediate data storage device comprises a conveyor device coupled to a conveyor belt, the conveyor device receiving information from the data collection terminal and transmitting the information to said central data collection facility.

15. The integrated data collection and transmission system for package tracking as recited in claim 1, wherein said intermediate data storage device comprises an interface device that receives information from the data collection terminal and transmits the data to the central data collection facility via a telephone line.

16. The integrated data collection and transmission system for package tracking as recited in claim 1, wherein said intermediate data storage device comprises an impulse radio transceiver capable of data transfer between a plurality of data collection terminals and the central data collection facility.

17. The integrated data collection and transmission system for package tracking as recited in claim 16, wherein the data collection device includes a recharger for recharging a battery of the data collection terminal.

18. The integrated data collection and transmission system for package tracking as recited in claim 16, wherein a memory of the data collection device is emptied upon transfer by the data transceiver device.

19. The integrated data collection and transmission system for package tracking as recited in claim 1, wherein said intermediate data storage device comprises a data collection device that is body wearable.

20. The integrated data collection and transmission system for package tracking as recited in claim 19, wherein said data storage device comprises:
an impulse radio transceiver, for receiving information into the data storage device;
a power supply, for supplying power to the data storage device;
an intermediate range radio, for transferring information from said data storage device; and
a memory, for storing data in said data storage device.

21. The integrated data collection and transmission system for package tracking as recited in claim 19, wherein said data storage device transmits the collected and stored package tracking data to one of the central data collection facility and a second intermediate storage device.

22. The integrated data collection and transmission system for package tracking as recited in claim 1, wherein the data collection terminal is powered by a battery and includes a smart battery system capable of providing information about battery usage and power level to the informational display.

23. The integrated data collection and transmission system for package tracking as recited in claim 22, wherein the smart battery system shuts down the data collection terminal at a preselected power level.

24. The integrated data collection and transmission system for package tracking as recited in claim 22, wherein the smart battery system periodically determines the power consumed by the data collection terminal and controls at least one of the output or operation of the data collection terminal based on that determination.

25. The integrated data collection and transmission system for package tracking as recited in claim 24, wherein said smart battery system controls the manner in which the battery is recharged, based on the determination of power consumption.

26. The integrated data collection and transmission system for package tracking as recited in claim 1, wherein said data collection terminal further comprises:
an informational display, which displays information regarding data collection;
a central processing unit (CPU);
a memory, coupled to said CPU, for storing information relative to data collection;
means for inputting information relative to data collection to the data collection terminal; and
a power supply, coupled to the CPU, which supplies power to the data collection terminal.

27. The integrated data collection and transmission system for package tracking as recited in claim 26, wherein the means for inputting comprises a keyboard.

28. The integrated data collection and transmission system for package tracking as recited in claim 26, wherein the means for inputting information includes a bar code scanner.

29. The integrated data collection and transmission system for package tracking as recited in claim 26, wherein the means for inputting comprises a touch screen.

30. The integrated data collection and transmission system for package tracking as recited in claim 29, wherein the informational display is capable of receiving information from a stylus device.

31. The integrated data collection and transmission system for package tracking as recited in claim 26, wherein the data collection terminal contains stored data regarding package shipping and outputs the data to the touchscreen via impulse radio means.

32. The integrated data collection and transmission system for package tracking as recited in claim 31, wherein said stored data comprises at least one of shipping costs, customer data, a common customer list, cash-only customers, international delivery information, dispatch information, courier input information, dangerous goods information, instructional information, performance feedback, news updates, a service reference guide, maps, zip code information, and address verification.

33. The integrated data collection and transmission system for package tracking as recited in claim 1, wherein said at least one peripheral device comprises an admonishment device for advising a customer whether a package pickup has been made.

34. The integrated data collection and transmission system for package tracking as recited in claim 21, wherein the storage facility is a drop box with a lock that is opened and closed in response to a communication from the data collection terminal.

35. The integrated data collection and transmission system for package tracking as recited in claim 33, wherein said admonishment device is coupled to a storage facility and said at least one impulse radio communication activates the admonishment device to advise the customer whether package pickup has been made.

36. The integrated data collection and transmission system for package tracking as recited in claim 35, wherein said admonishment device comprises a rotatable wheel and associated electronics.

37. The integrated data collection and transmission system for package tracking as recited in claim 35, wherein the storage facility is a drop box.

38. The integrated data collection and transmission system for package tracking as recited in claim 35, wherein said admonishment device comprises an informational display.

39. The integrated data collection and transmission system for package tracking as recited in claim 38, wherein said informational display comprises one of an LCD, a series of LEDs, and a vacuum florescent display.

40. A method of tracking package data using an integrated data collection and transmission system, the method comprising the steps of:
using a bar code scanner to collect and store package tracking data;
transmitting a communication to a peripheral device via impulse radio communications, the peripheral device performing a preselected operation related to package tracking based on the command;
transmitting the collected and stored package tracking data to an intermediate data storage device via impulse radio communications;
transmitting the collected and stored package tracking data to a central data facility; and
maintaining an accessible package tracking database based on the collected and stored package tracking data.

41. An integrated data collection and transmission system having an impulse radio communications link as one of its components comprising:
one or more bar code scanning devices, each having a memory, an informational display, a CPU, a keyboard for inputting information to the device, a power supply, and an impulse radio communications port for communicating with selected other components of the system including other of the bar code scanners;
one or more intermediate data storage and processing devices provided with an impulse radio communications port for receiving information from one of the one or more bar code scanning devices and for communicating with the selected other components of the system;
a printer with an impulse radio communications port capable of receiving a print command from one of the one or more bar code scanning devices; and
a central computer with means for accepting, storing and transmitting data to and between the one or more intermediate data storage and processing devices.

42. The system according to claim 41, further comprising one or more central stations at sites for storage, sorting, loading and conveying articles in transit, said one or more control stations having an impulse radio communications port with selected other components of the system.

43. The system according to claim 41, further comprising one or more storage facilities having controlled access activated by signals communicated via an impulse radio communications link.

44. The system according to claim 43, wherein said access is activated by a said an impulse radio coming within a predetermined range of said storage facility as determined by impulse radio distance determination techniques.
